(19) United States
(12) Patent Application Publication
(10) Pub. No.: US 2025/0310975 A1
(43) Pub. Date: Oct. 2, 2025

(54) Wireless Audio Data Transmission Method, System, and Device

(71) Applicant: Zgmicro Wuxi Corporation, Wuxi (CN)

(72) Inventor: Bin XU, Wuxi (CN)

(21) Appl. No.: 19/097,859

(22) Filed: Apr. 2, 2025

(30) Foreign Application Priority Data
Apr. 2, 2024 (CN) 2024103941655
Jan. 15, 2025 (CN) 2025100684818

(51) Int. Cl. H04W 72/30; H04W 76/10

(52) U.S. Cl. CPC H04W 72/30; H04W 76/10

(57) ABSTRACT

A wireless audio data transmission method, system, and device are disclosed, pertaining to the field of wireless audio communication. The method, when applied to a master device, includes: establishing a primary broadcast communication link; establishing a corresponding secondary broadcast communication link for each of one or more secondary devices; broadcasting a primary broadcast data packet via the primary broadcast communication link; and receiving, within one isochronous interval of consecutive multiple isochronous intervals, a secondary broadcast data packet broadcast by each secondary device via the corresponding secondary broadcast communication link. The time slot for broadcasting the primary broadcast data packet and the time slots for broadcasting the secondary broadcast data packets within the same isochronous interval do not overlap. This configuration enables the master device and multiple secondary devices to synchronously broadcast multi-channel audio over distinct broadcast communication links, thereby supporting a many-to-numerous interactive wireless communication architecture.

### FIELD OF THE INVENTION

The present invention relates to the technical field of wireless audio, specifically relates to a wireless audio data transmission method, a wireless audio data transmission system, and a wireless audio data transmission device.

### DESCRIPTION OF THE RELATED ART

Bluetooth Low Energy (BLE) Audio technology employs a Synchronous Isochronous Channels protocol, which comprises a Connected Isochronous Stream (CIS) link for point-to-point communication and a Connected Isochronous Group (CIG) link protocol composed of at least one CIS link, as well as a Broadcast Isochronous Stream (BIS) link for point-to-multipoint communication and a Broadcast Isochronous Group (BIG) link protocol composed of at least one BIS link. It can offer users wireless audio services with lower power consumption, lower cost, lower latency, higher quality, and greater variety.

The related technology using the BIG link can achieve a Wireless Broadcast Audio (WBA) function for point-to-multipoint communication. However, in practical applications, it has been found that the existing BIG link only supports a single transmitting device to synchronously broadcast multi-channel audio through multiple BIS links but does not support multiple transmitting devices to synchronously broadcast multi-channel audio through multiple BIS links.

### SUMMARY OF THE INVENTION

The purpose of the present invention is to provide a wireless audio data transmission method, a wireless audio data transmission system, and a wireless audio data transmission device, which are used to solve the technical problem in the related art that multiple transmitting devices are not supported to synchronously broadcast multi-channel audio.

To achieve the purpose, according to one aspect of the present invention, a wireless audio data transmission method applied to a master device is provided. The method comprises: establishing a primary broadcast communication link; establishing a corresponding secondary broadcast communication link for each of one or more secondary devices; and broadcasting a primary broadcast data packet via the primary broadcast communication link, and receiving a secondary broadcast data packet broadcast by each secondary device via the corresponding secondary communication link within one isochronous interval of consecutive multiple isochronous intervals. A time slot for broadcasting the primary broadcast data packet and a time slot for broadcasting the secondary broadcast data packet within the same isochronous interval are not overlapped with each other.

According to another aspect of the present invention, a wireless audio data transmission method applied to a first secondary device is provided. The method comprises: establishing a primary broadcast communication link with a master device; establishing a secondary broadcast communication link through the master device; and receiving a primary broadcast data packet broadcast by the master device via the primary broadcast communication link, and broadcasting a corresponding secondary broadcast data packet via the secondary broadcast communication link, and/or receiving a corresponding secondary broadcast data packet broadcast by a second secondary device via the secondary broadcast communication link corresponding to the second secondary device within one isochronous interval of consecutive multiple isochronous intervals. A time slot for broadcasting the primary broadcast data packet and a time slot for broadcasting the secondary broadcast data packet within the same isochronous interval are not overlapped with each other.

According to another aspect of the present invention, a wireless audio data transmission system is provided. The system comprises: a master device and one or more secondary devices. The master device establishes a primary broadcast communication link with the one or more secondary devices, and each secondary device establishes a corresponding secondary broadcast communication link through the master device. The master device is configured for: broadcasting a primary broadcast data packet via the primary broadcast communication link, and receiving a secondary broadcast data packet broadcast by each secondary device via the corresponding secondary communication link within one isochronous interval of consecutive multiple isochronous intervals. A time slot for broadcasting the primary broadcast data packet and a time slot for broadcasting the secondary broadcast data packet within the same isochronous interval are not overlapped with each other.

In the present invention, the master device is configured to establish a primary broadcast communication link and establish a corresponding secondary broadcast communication link for each of one or more secondary devices. Thus, within one of consecutive isochronous intervals, the master device can broadcast a primary broadcast data packet based on the primary broadcast communication link, and each secondary device can broadcast the corresponding secondary broadcast data packet based on the secondary communication link corresponding to each secondary device, thereby supporting a plurality of transmitting devices to synchronously broadcast multi-channel audio over a plurality of broadcast communication links, and realizing a many-to-numerous (M2N) interactive wireless communication function.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 illustrates a flowchart illustrating a wireless audio data transmission method, in accordance with an embodiment of the present invention;

FIG. 2 illustrates a schematic diagram showing a format for extended advertising payloads, in accordance with an embodiment of the present invention;

FIG. 3 illustrates a schematic diagram of an extended header format, in accordance with an embodiment of the present invention;

FIG. 4 illustrates a schematic representation of extended header flag bits, in accordance with an embodiment of the present invention;

FIG. 5 illustrates a flowchart showing a process for establishing a distributed broadcast communication link group, in accordance with an embodiment of the present invention;

FIG. 6 illustrates a flowchart illustrating a joining process for a secondary device in a distributed broadcast communication environment, in accordance with an embodiment of the present invention;

FIG. 7 illustrates a flowchart illustrating a wireless audio data transmission method, in accordance with an embodiment of the present invention;

FIG. 8 illustrates a block diagram of a wireless audio data transmission system, in accordance with an embodiment of the present invention;

FIG. 9 illustrates a schematic representation of a timeslot structure for a distributed broadcast isochronous group, in accordance with an embodiment of the present invention;

FIG. 10 illustrates a functional block diagram of a wireless audio data transmission device, in accordance with an embodiment of the present invention;

FIG. 11 illustrates a functional block diagram of a wireless audio data transmission device, in accordance with an embodiment of the present invention;

FIG. 12 illustrates a schematic block diagram of an example electronic device, in accordance with an embodiment of the present invention;

FIG. 13 is a flowchart showing a process for a master transmitting device to establish or expand a broadcast isochronous cluster, in accordance with an embodiment of the present invention;

FIG. 14 illustrates a flowchart showing a process for a candidate transmitting device to join a broadcast isochronous cluster, in accordance with an embodiment of the present invention;

FIG. 15 illustrates a flowchart illustrating a receiving device's synchronization and data reception process, in accordance with an embodiment of the present invention.

FIG. 16 illustrates a schematic diagram of a time-slot structure, in accordance with an embodiment of the present invention; and

FIG. 17 illustrates a block diagram of a wireless audio data transmission system, in accordance with an embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

As used herein, references to “one embodiment” or “an embodiment” indicate that a particular feature, structure, or characteristic described in connection with the embodiment may be included in at least one implementation of the invention. The various appearances of “in one embodiment” are not necessarily all referring to the same embodiment, and the different embodiments are not necessarily mutually exclusive. Moreover, the ordering of blocks in process flow diagrams does not inherently specify a required order or imply limitations.

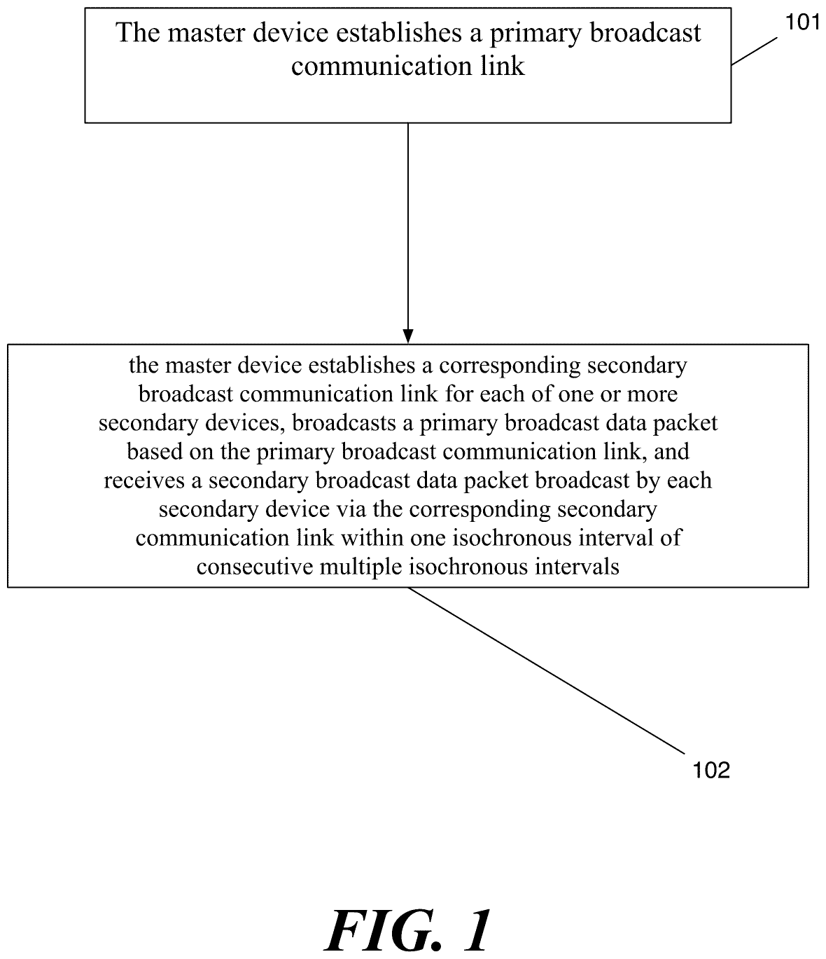

According to one embodiment, a method for wireless audio data transmission is implemented by a master device. As shown in FIG. 1, the method comprises the following operations. At 101, the master device establishes a primary broadcast communication link. At 102, the master device: establishes a corresponding secondary broadcast communication link for each of one or more secondary devices; broadcasts a primary broadcast data packet via the primary broadcast communication link; and receives a secondary broadcast data packet from each secondary device via the corresponding secondary communication link, all within a single isochronous interval of multiple consecutive isochronous intervals.

Within the same isochronous interval, the time slot used by the master device to transmit the primary broadcast data packet does not overlap with the time slot used by any secondary device to transmit its secondary broadcast data packet. In this configuration, the master device establishes the primary broadcast communication link and, for each secondary device, a corresponding secondary broadcast communication link. Accordingly, within a given isochronous interval, the master device transmits the primary broadcast data packet, and each secondary device transmits its own secondary broadcast data packet using its respective communication link. This supports synchronous multi-channel audio broadcasting by multiple transmitting devices across multiple broadcast communication links and enables a many-to-numerous (M2N) interactive wireless communication architecture.

This method is applicable in scenarios such as multi-point-to-multipoint wireless broadcast audio (WBA) systems. For example, in a wireless multi-microphone conference setting, the master device may be an audio device (e.g., a wireless headset) used by a meeting host or keynote speaker, while the secondary devices may be similar audio devices used by other participants. Alternatively, in a group travel or hiking scenario, the master device may be associated with a team leader, while the secondary devices may belong to deputy leaders or other team members.

In some embodiments, the primary broadcast communication link may include one or more links, and each secondary broadcast communication link may likewise consist of one or more links. Furthermore, the audio data transmitted in the primary broadcast data packet during one of the consecutive isochronous intervals differs from the audio data transmitted in the secondary broadcast data packets from each secondary device in that same interval.

In one embodiment, the set of the primary and secondary broadcast communication links forms a broadcast communication link group. Without loss of generality, the primary broadcast communication link may be understood as a Broadcast Isochronous Stream (BIS) link, the secondary broadcast communication link may also be considered a BIS link, and the broadcast communication link group may correspond to a Broadcast Isochronous Group (BIG).

To distinguish this configuration from the aforementioned BIS and the BIG, the present invention defines the broadcast communication link group as a Distributed Broadcast Isochronous Group (DBIG). Within this group: the primary broadcast communication link is defined as a Primary Broadcast Isochronous Stream (PBIS); and the secondary broadcast communication link is defined as a Secondary Broadcast Isochronous Stream (SBIS). The DBIG thus comprises at least two Distributed Broadcast Isochronous Stream (DBIS) links, which include both the PBIS and one or more SBIS links.

With this configuration, the master device's PBIS not only enables secondary devices to receive its primary broadcast data packet but also allows other devices with audio playback capabilities to access and receive this packet. Likewise, each SBIS enables its corresponding secondary device to transmit its audio data not only to the master device and other secondary devices, but also to other compatible audio playback devices.

By leveraging existing Isochronous Channel protocols, this architecture provides for many advantages in various embodiments. It supports synchronized multi-channel audio broadcasting by multiple transmitters using multiple BIS links. It enables many-to-numerous wireless communication between the master device and one or more secondary devices. It allows additional listener devices (i.e., devices other than the master and secondary devices that support audio playback) to join the PBIS and/or SBIS links and receive broadcast audio data from either the master device or a secondary device.

This compatibility with devices supporting the Isochronous Channels protocol expands the ecosystem of devices that can participate in the many-to-numerous wireless communication system described herein. In one embodiment of the application described herein, by reusing the existing Isochronous Channels protocol, it can not only support multiple transmitting devices to synchronously broadcast multi-channel audio through multiple BIS links, achieving the many-to-numerous interactive wireless communication function between the master device and one or more secondary devices, but also support one or more listener devices (which can be understood as other devices with audio playback functions except the master device and the secondary devices) to access the primary/secondary broadcast communication links and receive the primary broadcast data packet broadcast by the master device and/or the secondary broadcast data packet broadcast by the corresponding secondary device. This enables the solution described in the present invention to be effectively compatible with the audio devices that support the Isochronous Channels protocol (which means that the audio devices can receive the primary broadcast data packet broadcast by the master device based on the primary broadcast communication link and receive the corresponding secondary broadcast data packet based on the secondary communication link corresponding to each secondary device), thereby expanding scope of the devices supported by the many-to-numerous interactive wireless communication function.

In one embodiment, the master device and one or more secondary devices form a Distributed Transmitter Set (DTS) using a set link. The method may further comprise the following operations. Transmitting a DTS synchronization search data packet via the set link. Receiving a DTS synchronization set request data packet from a candidate device in response to the search packet, where the request packet includes identifying link information such as the device address and device ID. If the candidate device is permitted to join the DTS based on this information, transmitting a DTS synchronization set configuration data packet, which contains the link information for the broadcast communication link group and a unique target identifier. Receiving a DTS synchronization set response packet from the candidate device in response to the DTS synchronization set configuration packet, thereby designating it as a secondary device and enabling it to establish an SBIS link according to the provided broadcast link information, wherein the target identifier uniquely identifies the secondary broadcast communication link corresponding to the candidate device within the broadcast communication link group.

The target identifier uniquely identifies the SBIS corresponding to the candidate device within the DBIG. This process enables a candidate device to join the DTS as a secondary transmitter via defined signaling packets and link configuration steps. The set link may be implemented using a Bidirectional Periodic Advertising (BPA) link or a Bluetooth Low Energy (BLE) Asynchronous Connection-Oriented (ACL) link.

In an exemplary implementation, protocol data units (PDUs) may be defined by referencing the Auxiliary Synchronization (AUX_SYNC_IND) PDU of the BLE protocol. These PDUs may include, without limitation: DTS Synchronization Search (DTS_SYNC_SEARCH) PDU—represents the DTS synchronization search packet; DTS Synchronization Set Request (DTS_SYNC_SET_REQ) PDU—represents the request from a candidate device; DTS Synchronization Set Configuration (DTS_SYNC_SET_CONFIG) PDU—represents the configuration sent by the master device; and DTS Synchronization Set Response (DTS_SYNC_SET_RSP) PDU—represents the acknowledgment and acceptance by the candidate device.

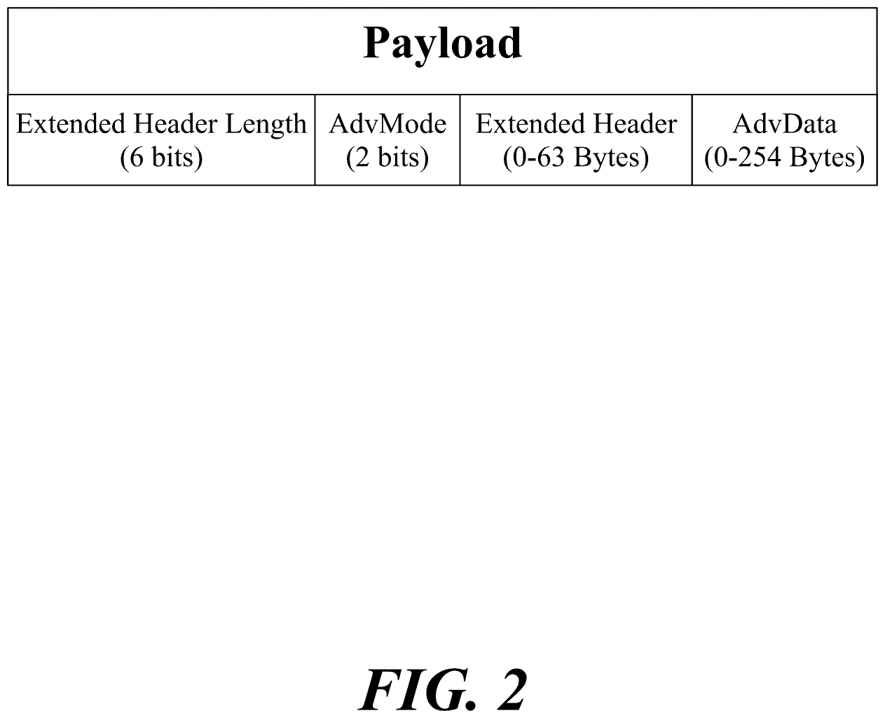

The AUX_SYNC_IND PDU adopts the Common Extended Advertising Payload Format defined in the BLE Audio specification (as illustrated in FIG. 2), comprising: a 6-bit Extended Header Length, a 2-bit Advertising Mode (AdvMode), an Extended Header of 0-63 bytes, and an Advertising Data (AdvData) of up to 254 bytes.

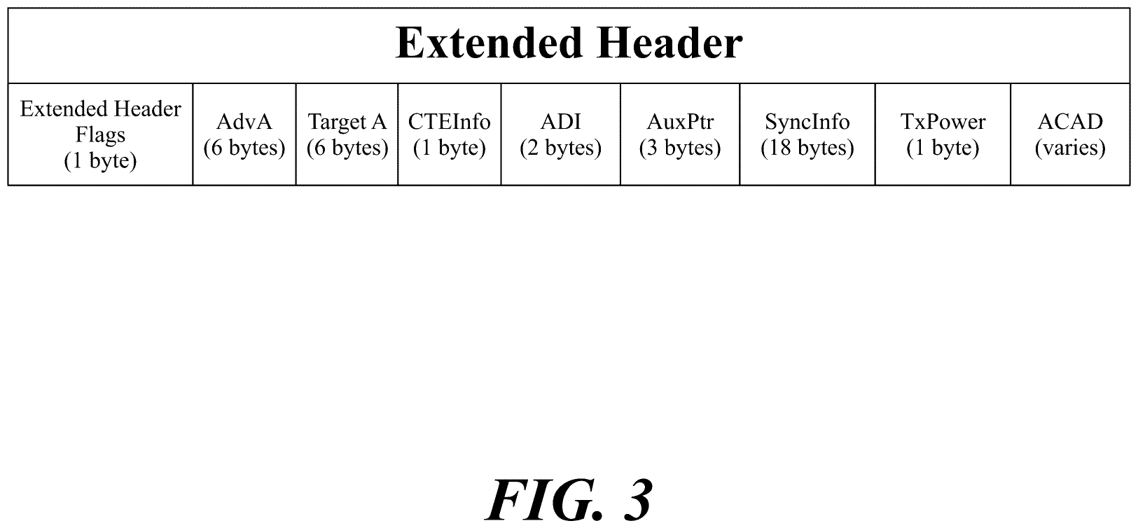

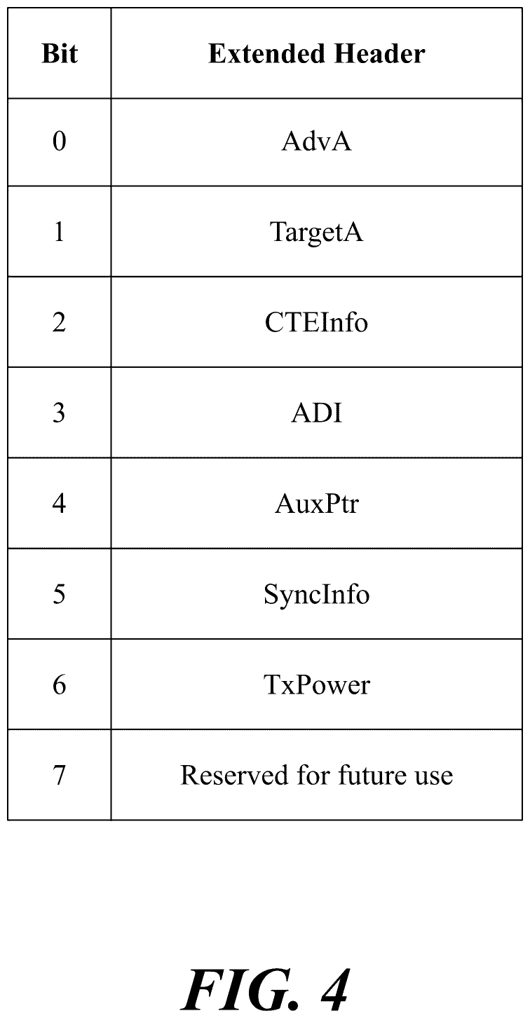

FIG. 3 illustrates an example of an extended header format. The extended header format may include, without limitation: Extended Header Flags, AdvA (advertiser address), TargetA (target device address), CTEInfo (Constant Tone Extension information), ADI (advertising data information), AuxPtr (auxiliary advertising pointer), SyncInfo (synchronization information), TxPower (transmit power), and ACAD (Additional Controller Advertising Data). The Extended Header Flags field indicates which of the above fields are present. As shown in FIG. 4, each bit corresponds to a particular field: a bit set to 1 signifies the presence of the corresponding field in the extended header, while a bit set to 0 indicates its absence. The AUX_SYNC_IND PDU includes the Broadcast Isochronous Group (BIG) Info within the ACAD field, enabling peripheral devices to receive broadcast audio via the BIG link.

Similar to the AUX_SYNC_IND PDU, the following PDUs all adopt the Common Extended Advertising Payload Format (see FIG. 2 in the BLE Audio specification): DTS_SYNC_SEARCH, DTS_SYNC_SET_REQ, DTS_SYNC_SET_CONFIG, and DTS_SYNC_SET_RSP. The primary distinctions between these PDUs and the AUX_SYNC_IND PDU lie in the contents of the Extended Header, different AdvMode field, and different contents of the AdvData.

Specifically, the DTS_SYNC_SEARCH PDU differs from the AUX_SYNC_IND PDU in that bit 0 of the Extended Header Flags is set to 1, indicating the presence of AdvA, which holds the master device's address. Other field values match those of the AUX_SYNC_IND PDU. The ACAD field contains the BIG Info, which serves as the link information for the broadcast communication link group. This PDU, with AdvMode set to 0b01 (undirected setting available type), is used by the master device to broadcast link information of the communication group to secondary and listener devices and discover secondary devices (i.e., candidate devices) that are ready to join the Distributed Transmitter Set (DTS). Similar to the AUX_SYNC_IND PDU, the DTS_SYNC_SEARCH PDU provides the link information of the broadcast communication link group to the secondary devices and the listener devices in the DTS, and is also used for the master device in the DTS to search for or discover the secondary devices ready to join the DTS (the secondary devices not yet joined the DTS can be understood as the aforementioned candidate devices). It should be pointed out that the link information of the aforementioned broadcast communication link group is exactly the same as definition of BIGInfo.

The DTS_SYNC_SET_REQ PDU sets both bit 0 and bit 1 of the Extended Header Flags to 1, indicating the presence of both AdvA and TargetA. AdvA holds the address of the secondary device requesting to join the DTS. TargetA holds the address of the master device. Unlike the AUX_SYNC_IND PDU, the ACAD field in this PDU does not carry BIG Info. The AdvMode is set to 0b11 (setting request type). The AdvData may include device-specific information such as a name or universally unique identifier (UUID). This PDU is used by a candidate device to request permission to join the DTS and establish its secondary broadcast communication link. The DTS_SYNC_SET_REQ PDU is used for the secondary device ready to join the DTS to request the master device in the DTS to allow it to establish the corresponding secondary broadcast communication link and join the broadcast communication link group.

The DTS_SYNC_SET_CONFIG PDU also sets bits 0 and 1 of the Extended Header Flags, including AdvA (master device address) and TargetA (secondary device address). The ACAD field carries the link information of the broadcast communication link group (BIG Info), and AdvMode is set to 0b10 (directed setting available type). The AdvData in this PDU includes a sequence number that uniquely identifies the newly established secondary broadcast communication link—this is the target identifier. This PDU informs secondary and listener devices of the link configuration and enables the secondary device to join the communication group.

The DTS_SYNC_SET_RSP PDU is structurally similar to the DTS_SYNC_SET_REQ and DTS_SYNC_SET_CONFIG PDUs. It also includes AdvA (secondary device address) and TargetA (master device address), with bits 0 and 1 set in the Extended Header Flags. However, the ACAD field does not carry BIG Info. The AdvMode is set to 0b00 (setting response type). This PDU is used by the secondary device to confirm its intent to join the DTS and acknowledge the establishment of its secondary broadcast communication link.

In one embodiment, the master device periodically transmits an AUX_SYNC_IND PDU carrying the broadcast communication link group's BIG Info. This allows listener devices to synchronize with the master device via the periodic advertising channel and receive both the primary broadcast data packet transmitted by the master device, and the secondary broadcast data packet transmitted by each secondary device.

As will be known to those of ordinary skill in the art, according to BLE protocol, BIG peripheral devices synchronize with a BIG central device using ADV_EXT_IND PDUs on the primary advertising channel, AUX_ADV_IND PDUs on a secondary advertising channel, and AUX_SYNC_IND PDUs on a periodic advertising channel. These PDUs allow devices to obtain BIG Info and subsequently receive BIS PDUs carrying audio data over the BIG link.

Similarly, the listener device synchronizes with the master device by sequentially receiving a series of advertising packets transmitted over different advertising channels. Initially, the listener device detects the ADV_EXT_IND PDU transmitted by the master device on the primary advertising channel. It then receives the AUX_ADV_IND PDU on the secondary advertising channel, followed by one of several possible synchronization packets-such as the AUX_SYNC_IND PDU, the DTS_SYNC_SEARCH PDU, or the DTS_SYNC_SET_CONFIG PDU—transmitted on the periodic advertising channel. Through this sequence, the listener device establishes synchronization with the master device operating as part of either the Distributed Broadcast Isochronous Group (DBIG) or the Distributed Transmitter Set (DTS). Upon successful synchronization, the listener device obtains the link information associated with the broadcast communication link group, enabling it to receive both the primary broadcast data packet transmitted over the primary broadcast communication link and the secondary broadcast data packets transmitted over one or more secondary broadcast communication links, along with the respective audio data carried by those packets.

Similarly, the secondary device initiates synchronization with the master device by first detecting the ADV_EXT_IND PDU transmitted on the primary advertising channel, followed by reception of the AUX_ADV_IND PDU on the secondary advertising channel. It then receives one of several synchronization packets—such as the AUX_SYNC_IND PDU, the DTS_SYNC_SEARCH PDU, or the DTS_SYNC_SET_CONFIG PDU—transmitted on the periodic advertising channel. This sequence enables the secondary device to synchronize with the master device operating as part of the Distributed Broadcast Isochronous Group (DBIG). Once synchronization is established, the secondary device engages in a link establishment exchange with the master device by transmitting and receiving a series of protocol data units: DTS_SYNC_SEARCH, DTS_SYNC_SET_REQ, DTS_SYNC_SET_CONFIG, and DTS_SYNC_SET_RSP. Through this exchange, the secondary device joins the broadcast communication link group or becomes part of the Distributed Transmitter Set (DTS).

The communication link over which this exchange occurs is referred to as a bidirectional periodic advertising (BPA) link. The process begins when the master device, either automatically or via user interface (UI) control, enters a DBIG establishment mode and begins transmitting the DTS_SYNC_SEARCH PDU on the periodic advertising channel.

Upon receiving the DTS_SYNC_SEARCH PDU, a secondary device intending to join the DBIG replies with a DTS_SYNC_SET_REQ PDU after a predefined inter-frame space (T_IFS). According to the Bluetooth Low Energy (BLE) protocol, T_IFS may be 150 microseconds, although it may vary based on future protocol revisions. When the master device receives the DTS_SYNC_SET_REQ PDU, it evaluates whether to authorize the secondary device to join the DBIG based on identifying information such as device address, device name, or UUID. If approved, the master device transmits a DTS_SYNC_SET_CONFIG PDU to the secondary device, specifying the link configuration, including a sequence number for the Distributed Broadcast Isochronous Stream (DBIS) link.

Once the secondary device receives the DTS_SYNC_SET_CONFIG PDU, it responds by transmitting a DTS_SYNC_SET_RSP PDU after another T_IFS interval, thereby confirming its inclusion in the DBIG. If the master device does not receive this response, it will retransmit the DTS_SYNC_SET_CONFIG PDU until a correct DTS_SYNC_SET_RSP PDU is received. After this confirmation, the secondary device can establish its DBIS link based on the sequence number and link configuration information provided in the DTS_SYNC_SET_CONFIG PDU, and schedule transmission time slots for its Secondary Broadcast Isochronous Stream (SBIS) accordingly. It is important to note that only the secondary device with the specified address indicated in the DTS_SYNC_SET_CONFIG PDU is permitted to reply with a DTS_SYNC_SET_RSP PDU.

To avoid collision from multiple secondary devices responding simultaneously, each secondary device introduces a randomized delay after receiving the DTS_SYNC_SEARCH PDU and completing synchronization. This delay spans several BIG isochronous intervals (USO Intervals), and the secondary device will only attempt to transmit its DTS_SYNC_SET_REQ PDU after receiving a subsequent DTS_SYNC_SEARCH PDU.

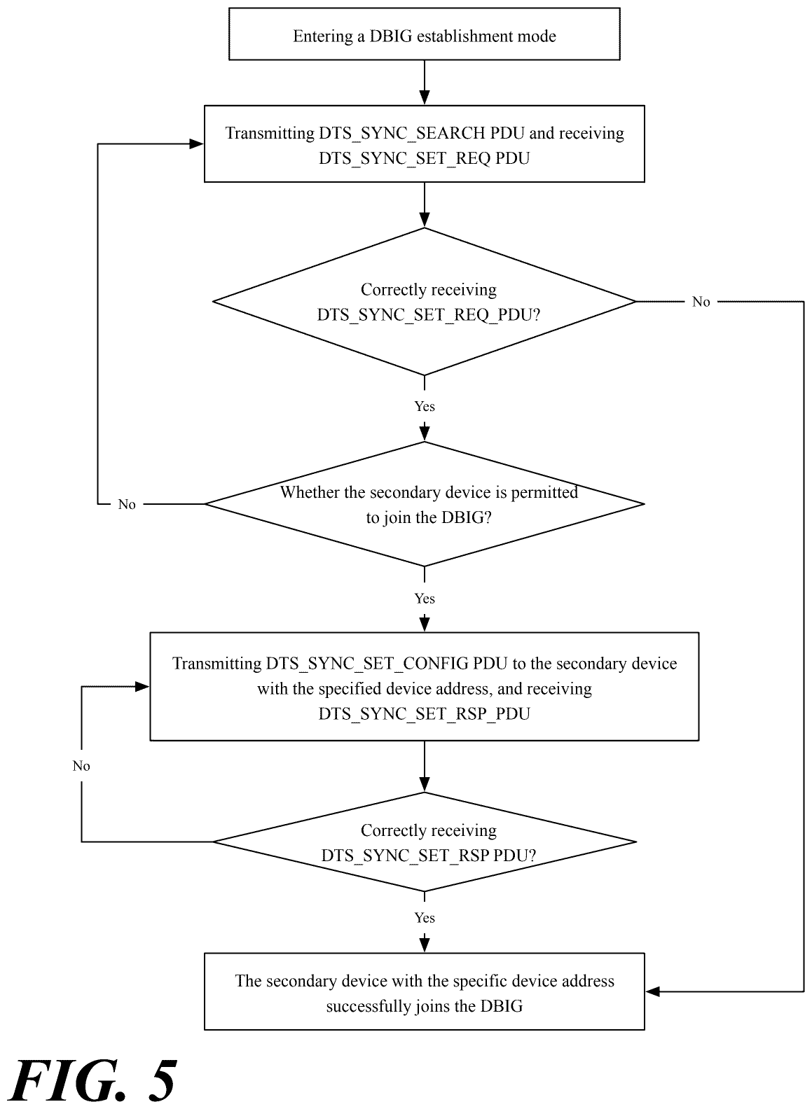

As illustrated in FIG. 5, the process by which the master device establishes a Distributed Broadcast Isochronous Group (DBIG) begins when the master device enters a DBIG establishment mode. In this mode, the master device initiates communication by transmitting a DTS_SYNC_SEARCH PDU on the periodic advertising channel and awaits receipt of a DTS_SYNC_SET_REQ PDU from a secondary device. If the DTS_SYNC_SET_REQ PDU is not correctly received, the master device continues broadcasting the DTS_SYNC_SEARCH PDU, maintaining readiness to receive valid requests.

Upon successfully receiving a DTS_SYNC_SET_REQ PDU and determining that the secondary device associated with the request is permitted to join the DBIG—typically based on device address or other identifying information—the master device transmits a DTS_SYNC_SET_CONFIG PDU addressed to that secondary device. If the secondary device responds with a DTS_SYNC_SET_RSP PDU, the joining process is confirmed, and the secondary device is considered successfully added to the DBIG. If the DTS_SYNC_SET_RSP PDU is not received, the master device will continue to retransmit the DTS_SYNC_SET_CONFIG PDU until a valid response is obtained or a timeout condition is met.

Once a secondary device has successfully joined, the master device resumes broadcasting the DTS_SYNC_SEARCH PDU to discover and connect with additional secondary devices, repeating the same handshake procedure for each. This iterative process continues until the desired number of secondary devices have been integrated into the DBIG.

When the DBIG has reached its intended size, the master device exits the DBIG establishment mode and discontinues transmission of the DTS_SYNC_SEARCH PDU. Thereafter, it begins transmitting the AUX_SYNC_IND PDU, which is used by listener devices to synchronize with the master device and acquire the DBIG information necessary to receive and decode audio streams.

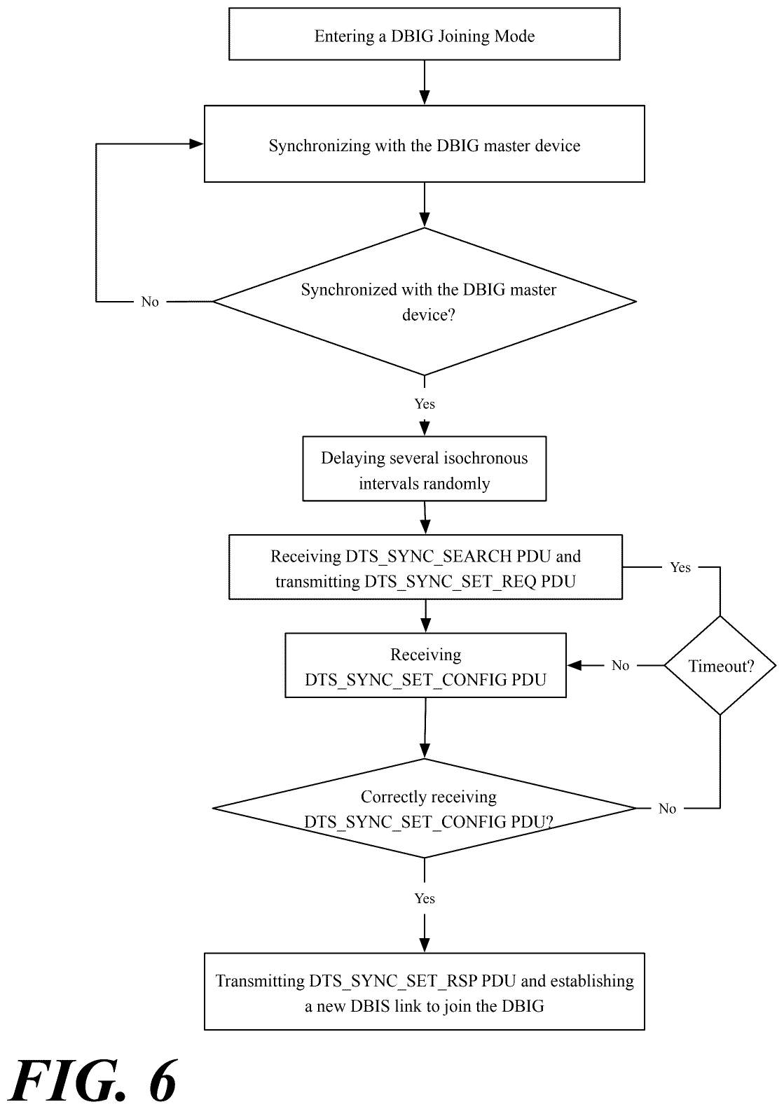

As illustrated in FIG. 6, the process by which a secondary device establishes a corresponding Distributed Broadcast Isochronous Stream (DBIS) link and joins the Distributed Broadcast Isochronous Group (DBIG) begins when the secondary device enters a DBIG joining mode. To initiate synchronization, the secondary device searches for the ADV_EXT_IND PDU transmitted by the master device on the primary advertising channel. Upon receiving the ADV_EXT_IND PDU, it subsequently receives the AUX_ADV_IND PDU on the secondary advertising channel and then receives the DTS_SYNC_SEARCH PDU on the periodic advertising channel. These packets enable the secondary device to synchronize with the master device of the DBIG.

Once synchronization is achieved, the secondary device waits for a random delay spanning several isochronous intervals to mitigate potential interference from other secondary devices attempting to transmit DTS_SYNC_SET_REQ PDUs simultaneously. After this delay, and upon receiving the DTS_SYNC_SEARCH PDU again, the secondary device transmits the DTS_SYNC_SET_REQ PDU after an inter-frame space interval (T_IFS). For improved reliability, the secondary device may repeat this process across multiple isochronous intervals, ensuring multiple opportunities for a successful exchange.

Following transmission of the DTS_SYNC_SET_REQ PDU, the secondary device awaits the DTS_SYNC_SET_CONFIG PDU from the master device. If this configuration packet is received correctly, the secondary device responds with a DTS_SYNC_SET_RSP PDU after an interval of T_IFS, thereby confirming its intent to establish the DBIS link and join the DBIG. In the event that the DTS_SYNC_SET_CONFIG PDU is not received or is corrupted, the secondary device continues monitoring for valid configuration packets until a timeout condition occurs. Upon timeout, the device resumes the discovery process by listening for the DTS_SYNC_SEARCH PDU and repeating the request cycle until the link is successfully established.

Notably, a secondary device within the DBIG may exit the group or the Distributed Transmitter Set (DTS) at any time. Likewise, a listener device may request to join the DBIG and assume the role of a secondary device. These dynamic capabilities support a more flexible and scalable many-to-numerous interactive wireless communication architecture.

In one embodiment, the isochronous interval is subdivided into multiple sub-event intervals. Within one of these sub-event intervals, the master device transmits a primary broadcast data packet via the primary broadcast communication link, while simultaneously receiving secondary broadcast data packets transmitted by each of the secondary devices over their respective secondary communication links. This configuration ensures that both the master and the secondary devices are afforded at least one broadcast opportunity during each isochronous interval, thereby mitigating potential delays in audio transmission for any participating device.

In some implementations, each sub-event interval within the isochronous interval may support a similar structure, wherein the primary broadcast data packet is transmitted by the master device and the secondary broadcast data packets are received from the secondary devices. This approach provides more consistent broadcast opportunities across the group, helping to further minimize latency and achieve a balanced distribution of transmission time among the devices in the broadcast communication link group.

Additionally, in one embodiment, the time slot allocated for the primary broadcast data packet within each sub-event interval precedes the time slot used for secondary broadcast data packets. This sequencing aligns with existing transmission conventions established under the BIS and BIG link protocols, allowing the present invention to maintain compatibility with current systems and thereby reduce the implementation complexity for both master and secondary devices.

In one embodiment, the method further includes transmitting a target data packet from the master device over either a first communication channel or a second communication channel, enabling each of the secondary devices to synchronize its clock with that of the master device. The first communication channel may be used to identify and establish links with secondary devices, while the second communication channel may be utilized by other devices, such as listener devices, for synchronization purposes. Because the master and secondary devices operate on independent clocks, there is a possibility of timing drift over extended operation. By receiving the target data packet, each secondary device can adjust its local clock to remain aligned with the master device, ensuring that the timing of their respective DBIS links remains consistent. This mechanism helps to prevent overlap between transmission time slots due to drift, thereby maintaining synchronization across audio streams transmitted over multiple DBIS links.

For example, the target data packet transmitted over the first communication channel may include a DTS synchronization search packet or a DTS synchronization set configuration packet. Alternatively, the target data packet transmitted over the second communication channel may be an auxiliary synchronization PDU that carries the link information for the broadcast communication link group.

In another embodiment, the method further comprises decoding the secondary broadcast data packets received via each secondary communication link to extract the corresponding audio content. Depending on the playback configuration of the master device, this decoded audio may then be either down-mixed into a single mono audio stream or rendered as discrete multi-channel audio. In the case where the master device supports only mono playback, it can combine the audio streams received from the secondary devices into a single mixed audio stream. Alternatively, if the master device supports multi-channel audio, it may render each stream individually as part of a multi-channel output, thereby preserving spatial separation or channel-specific content.

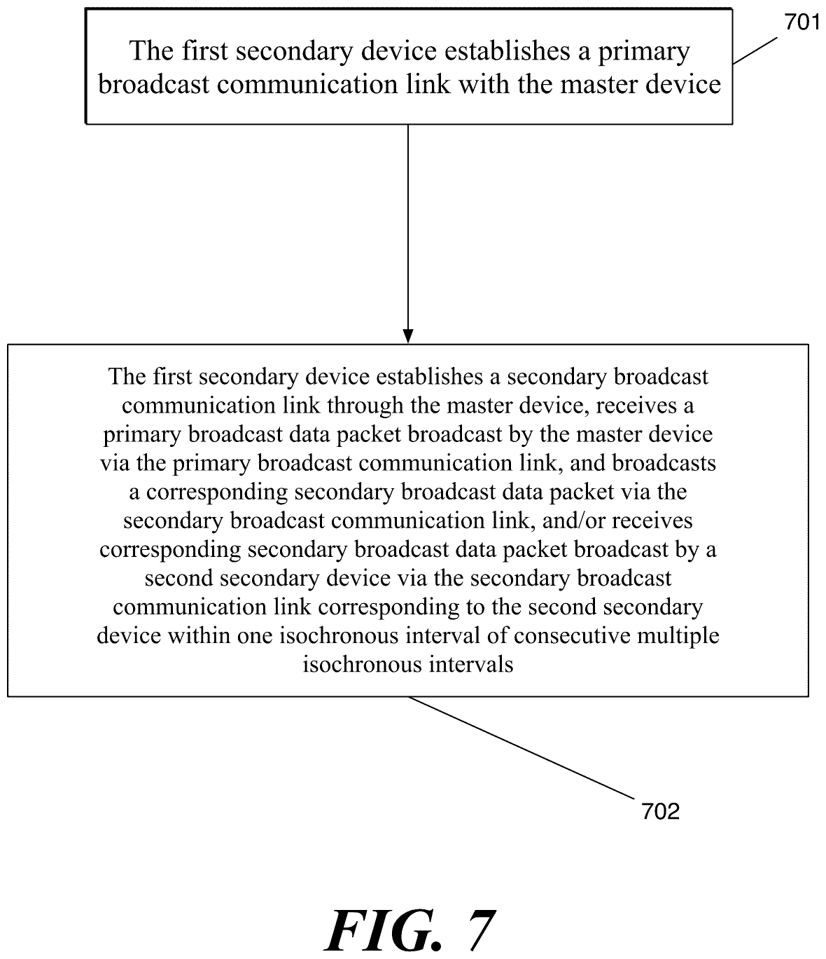

A wireless audio data transmission method applied to a first secondary device is provided in accordance with an embodiment of the present invention. As illustrated in FIG. 7, the method includes a sequence of operations through which the first secondary device participates in a distributed broadcast communication environment.

Initially at 701, the first secondary device establishes a primary broadcast communication link with a master device. Following this, in one embodiment, at 702, the secondary device establishes a secondary broadcast communication link through the master device. Once both links are established, the secondary device receives primary broadcast data packets from the master device via the primary broadcast communication link and transmits corresponding secondary broadcast data packets via the secondary broadcast communication link. In some cases, the secondary device may also receive a secondary broadcast data packet transmitted by another secondary device through the corresponding secondary communication link of that other device. These exchanges occur within a single isochronous interval of a sequence of consecutive isochronous intervals. Importantly, the time slot allocated for transmitting the primary broadcast data packet and the time slot allocated for transmitting the secondary broadcast data packet within the same isochronous interval do not overlap, thereby preventing transmission collisions and preserving audio synchronization.

It is to be understood that the first secondary device is one of a plurality of secondary devices in the system, and the second secondary device mentioned is another device from that group, distinct from the first. In one embodiment, the collection of the primary broadcast communication link and the secondary broadcast communication links associated with each of the secondary devices together form a broadcast communication link group. This group enables coordinated multi-device broadcasting of wireless audio data.

In another embodiment, the master device and the associated secondary devices collectively form a distributed transmitter set, established through a set link. To initiate the process of establishing a secondary broadcast communication link, the first secondary device receives a DTS synchronization search data packet transmitted by the master device over the set link. In response, the secondary device transmits a DTS synchronization set request data packet, which includes request link information such as the device address and a unique device identifier. If the master device determines that the requesting device is permitted to join the distributed transmitter set—based on the provided address and identifier—it transmits a DTS synchronization set configuration packet to the secondary device. This configuration packet includes link information for the broadcast communication link group and a target identifier that uniquely identifies the secondary broadcast communication link to be established. Upon receipt, the secondary device replies with a DTS synchronization set response packet, thereby confirming its role within the distributed transmitter set and establishing the designated secondary broadcast communication link using the provided link information and target identifier.

In one embodiment, the primary and secondary broadcast communication links correspond to a primary broadcast isochronous stream (PBIS) and a secondary broadcast isochronous stream (SBIS), respectively, while the combined structure forms a distributed broadcast isochronous group (DBIG). The set link used for coordination between the master and secondary devices may be implemented using either a bidirectional periodic advertising (BPA) link or a Bluetooth Low Energy (BLE) ACL link.

The method described here aligns with the processes previously discussed in connection with the operation of the secondary devices and therefore achieves similar technical effects. For brevity, those details are not repeated here.

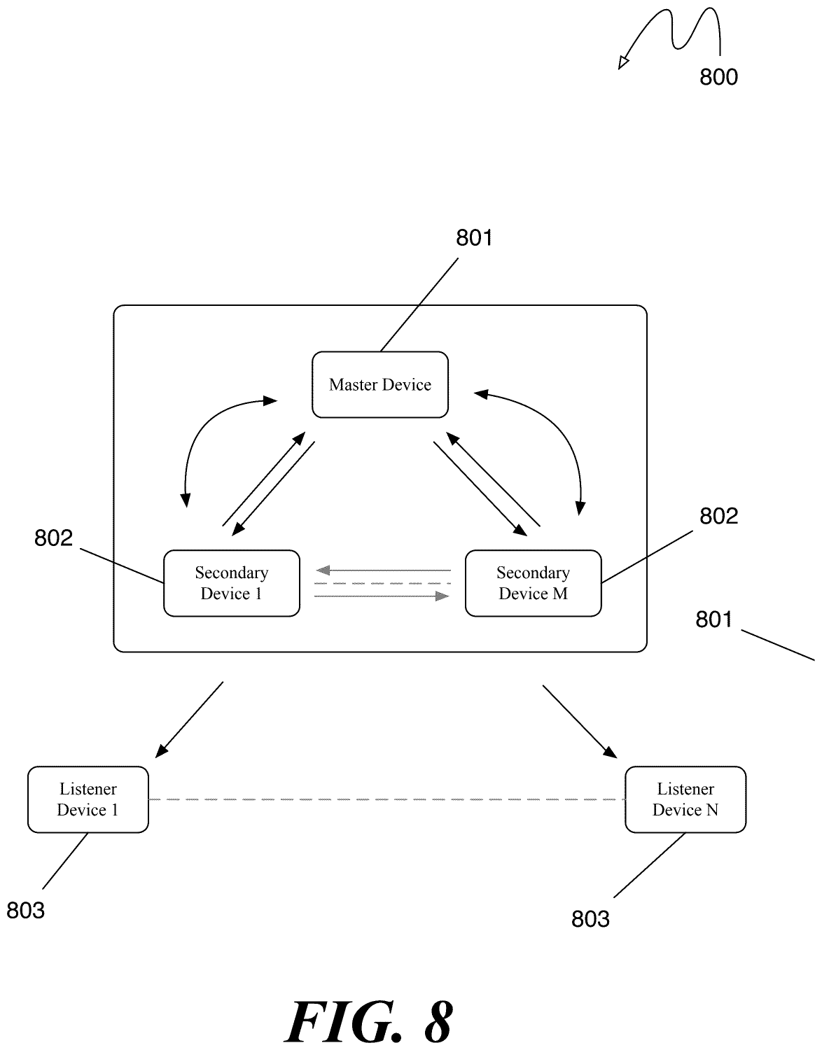

A wireless audio data transmission system is provided in accordance with an embodiment of the present invention. As shown in FIG. 8, the wireless audio data transmission system 800 comprises a master device 801 and one or more secondary devices 802. The master device 801 establishes a primary broadcast communication link with each of the secondary devices 802, and each secondary device 802 establishes a corresponding secondary broadcast communication link through the master device 801.

The master device 801 is configured to broadcast a primary broadcast data packet via the primary broadcast communication link and to receive secondary broadcast data packets broadcast by each secondary device 802 via their respective secondary communication links. These transmissions occur within a single isochronous interval of a sequence of consecutive isochronous intervals. Within any such interval, the time slot allocated for the primary broadcast data packet and the time slots for the secondary broadcast data packets are arranged so as not to overlap with one another.

In one embodiment, the primary and secondary broadcast communication links corresponding to each of the one or more secondary devices 802 together form a broadcast communication link group. The master device 801 and the secondary devices 802 may also form a distributed transmitter set through a set link. To support this, the master device 801 is further configured to transmit a DTS synchronization search data packet via the set link and to receive a DTS synchronization set request data packet sent in response by a candidate device. This request includes request link information such as a device address and a device identifier. If the master device 801 determines that the candidate device is permitted to join the distributed transmitter set, it transmits a DTS synchronization set configuration data packet that includes the link information of the broadcast communication link group and a target identifier. Upon receipt of a DTS synchronization set response packet from the candidate device, the master device 801 designates the candidate device as one of the secondary devices 802 and enables it to establish a corresponding secondary broadcast communication link based on the configuration, where the target identifier uniquely identifies the link within the group.

In one embodiment, the primary broadcast communication link may be a primary broadcast isochronous stream (PBIS) link, and each secondary broadcast communication link may be a secondary broadcast isochronous stream (SBIS) link. Together, these links may constitute a distributed broadcast isochronous group (DBIG). The set link used for coordination between the master device 801 and secondary devices 802 may be implemented using a bidirectional periodic advertising link or a BLE ACL link.

In some embodiments, the system 800 further comprises one or more listener devices 803. Each listener device 803 is configured to receive an auxiliary synchronization PDU transmitted by the master device 801 on a periodic advertising channel, where the auxiliary synchronization PDU carries the link information of the broadcast communication link group. Based on this information, the listener device 803 synchronizes with the master device 801 and receives the primary broadcast data packet via the primary broadcast communication link, as well as the secondary broadcast data packets via the respective secondary communication links from the secondary devices 802.

More generally, the wireless audio data transmission system 800 may be referred to as a Distributed Transmission Based Wireless Broadcast Audio (DTWBA) system. The DTWBA system includes one master device 801, at least one secondary device 802 (where M≥1), and optionally one or more listener devices 803 (where N≥0). In this architecture, the master device 801 and secondary devices 802 can function either as central or peripheral devices of the DBIG link, depending on the link structure. For instance, the listener device 803 operates as a peripheral device on the DBIG, PBIS, and SBIS links. The master device 801 acts as the central device on the PBIS link, while the secondary devices 802 act as peripheral devices. Conversely, when a secondary device 802 transmits its own audio data via an SBIS link, it acts as the central device of that link, with the master device 801 and other secondary devices 802 serving as peripheral devices. The listener device 803 in this case also acts as a peripheral device of the SBIS link.

The master device 801 may also be referred to as a DTWBA master device, a DBIG master device, or a DTS master device. Likewise, each secondary device 802 may be referred to as a DTWBA secondary device, a DBIG secondary device, or a DTS secondary device. Each listener device 803 may similarly be referred to as a DTWBA listener device, a DBIG listener device, or a DTS listener device.

To illustrate one exemplary application, consider a hiking team in which multiple members communicate with one another. In such a configuration, the master device 801 may be a wireless headset with a microphone used by the team leader. The secondary devices 802 are wireless headsets with microphones used by the deputy team leaders. The listener devices 803 are wireless headsets worn by the remaining team members, who only need to receive audio. In this example, there are three secondary devices 802 (M=3) and an unrestricted number of listener devices 803 (N>0). The DBIG link in this example comprises four DBIS links: one PBIS link and three SBIS links, supporting synchronized multi-channel audio communication among the team.

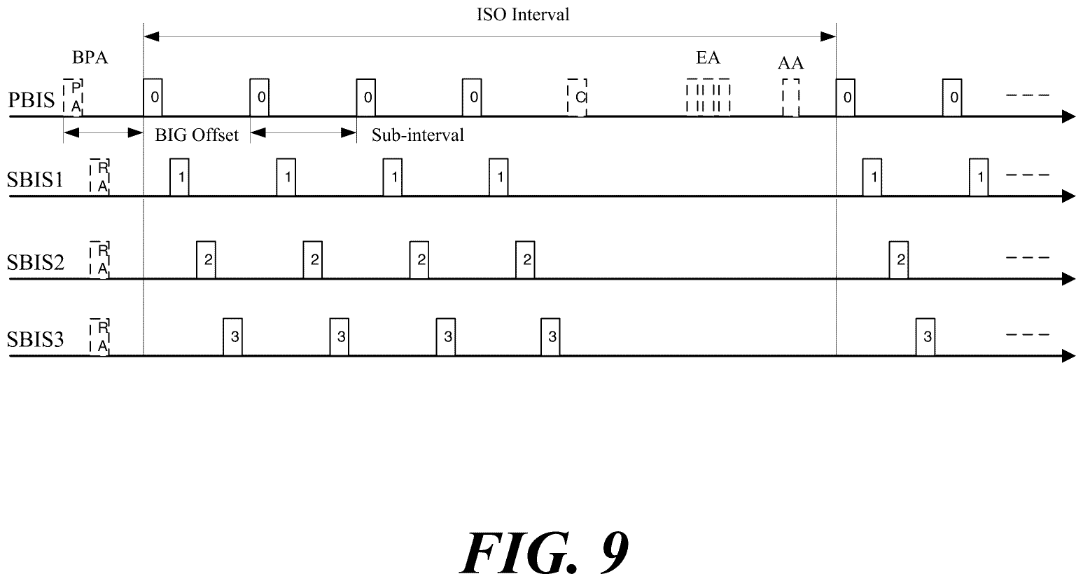

As illustrated in FIG. 9, the DBIG timeslot structure comprises four DBIS links, including one PBIS link and three SBIS links. In this structure, the respective time axes of the DBIS links are labeled as PBIS, SBIS1, SBIS2, and SBIS3. The boxes marked “0,” “1,” “2,” and “3” correspond to PDUs associated with the PBIS link and the three SBIS links, respectively. PDUs designated “PA” represent various types of packets including the AUX_SYNC_IND PDU, which is transmitted by the PBIS link over the periodic advertising channel. PDUs labeled “RA” represent packets such as the DTS_SYNC_SET_REQ PDU, which are transmitted by an SBIS link on the periodic advertising channel in response to the PA. Together, these PA and RA transmissions form a bidirectional periodic advertising (BPA) link. Additional labels in FIG. 9 include “C” for BIG control PDUs transmitted on the PBIS link, “EA” for ADV_EXT_IND PDUs transmitted over the primary advertising channel, and “AA” for AUX_ADV_IND PDUs transmitted on the secondary advertising channel. Dashed boxes indicate that the corresponding PDU may or may not be present in the current isochronous interval.

In terms of transmission parameters, each DBIS link in the DBIG operates with a frame length of 10 ms for LC3-encoded mono audio sampled at 16 kHz. The encoding rate is 32 kbps, and each Service Data Unit (SDU) comprises 40 bytes. The isochronous interval (ISO Interval) is set to 10 ms. There are four DBIS links, with the number of sub-events (NSE) equal to 4, a burst number (BN) of 1, an immediate repetition count (IRC) of 4, and a pre-transmission offset (PTO) value of 0. Each DBIS PDU contains one SDU, occupying 220 microseconds of airtime, with transmission conducted using a BLE 2 Mbps physical layer. The DBIS links operate in an interleaved mode, with a minimum slot spacing (T_MSS) of 150 microseconds and a sub-interval duration of 1480 microseconds. The periodic advertising interval is 60 ms, and the BIG offset—the time between the start of periodic advertising and the beginning of the BIG—is 1.23 ms. This parameter information is provided in the DBIG Info.

The master device and secondary devices establish the DBIG link composed of one PBIS link and three SBIS links using the process shown in FIG. 5 (for the master device) and FIG. 6 (for the secondary device). During operation, the master device and each secondary device not only transmit their own audio streams using their respective PBIS or SBIS links but also receive audio streams transmitted by the other DBIS links. Each device decodes up to three incoming channels of audio data and may either down-mix them for playback or output them separately as multi-channel audio.

Listener devices, such as wireless headsets worn by team members, synchronize with the master device using an existing BIG synchronization method. After synchronizing, each listener device receives DBIG Info, which enables it to receive and decode audio data from all four DBIS links. If the listener device supports mono-channel audio, it can down-mix the received audio streams for playback. Alternatively, if the listener device supports multi-channel playback, it may output each stream independently.

The secondary devices continually receive PDUs transmitted by the master device—particularly AUX_SYNC_IND PDUs on the periodic advertising channel—in order to align their internal clocks with that of the master. This ensures the relative timing of the PBIS and SBIS link transmissions remains stable, preventing overlap due to clock drift and thereby maintaining synchronization across audio streams.

It is worth noting that secondary devices may exit the DTS or DBIG configuration at any time. Additionally, listener devices equipped with microphones may request to join the DBIG as new secondary devices, thereby enhancing the flexibility and scalability of the system and enabling more users to actively participate in communication.

By employing the DBIG link structure, the present invention enables synchronized multi-channel wireless audio transmission among multiple transmitting devices. This effectively solves the limitations of the existing art and facilitates many-to-numerous interactive communications, while maintaining compatibility with conventional BIG-based audio devices acting as listener nodes.

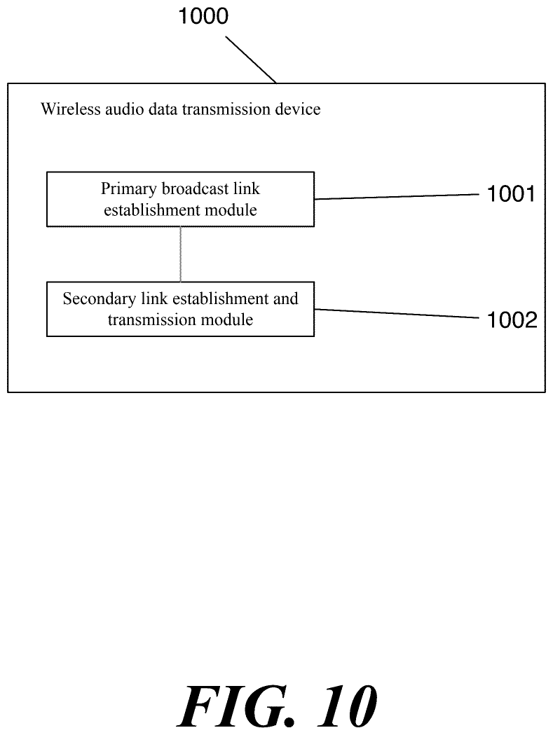

A wireless audio data transmission device applied to a master device is provided in accordance with an embodiment of the present invention. As shown in FIG. 10, the device 1000 comprises a primary broadcast link establishment module 1001, which is configured to establish a primary broadcast communication link, and a secondary link establishment and transmission module 1002, which is configured to establish a corresponding secondary broadcast communication link for each of one or more secondary devices.

The device 1000 is further configured to broadcast a primary broadcast data packet via the primary broadcast communication link, and to receive a secondary broadcast data packet from each secondary device via the corresponding secondary communication link within a single isochronous interval of a sequence of multiple isochronous intervals. The time slot for broadcasting the primary broadcast data packet and the time slot for broadcasting the secondary broadcast data packet within the same isochronous interval are arranged such that they do not overlap.

In one embodiment, the primary broadcast communication link and each of the secondary broadcast communication links together form a broadcast communication link group. The master device and the secondary devices may form a distributed transmitter set through a set link. In such an embodiment, the device 1000 further comprises a set module configured to manage the formation of this distributed transmitter set. The set module is operable to transmit a DTS synchronization search data packet via the set link, and to receive a DTS synchronization set request data packet sent in response by a candidate device. The DTS synchronization set request data packet includes request link information comprising a device address and a device identifier of the candidate device. Upon determining that the candidate device is permitted to join the distributed transmitter set, the set module transmits a DTS synchronization set configuration data packet carrying link information of the broadcast communication link group and a target identifier. Upon receipt of a DTS synchronization set response packet from the candidate device, the master device designates that device as a secondary device within the distributed transmitter set. The target identifier uniquely identifies the secondary broadcast communication link associated with the newly designated secondary device within the broadcast communication link group.

In one embodiment, the isochronous interval comprises multiple sub-event intervals. In such case, the secondary link establishment and transmission module 1002 is configured to broadcast the primary broadcast data packet via the primary broadcast communication link and to receive the secondary broadcast data packet via the corresponding secondary communication link within one of the sub-event intervals. Furthermore, within the sub-event interval, the time slot for the primary broadcast data packet may be positioned earlier than that for the secondary broadcast data packet, supporting compatibility with existing BIS and BIG link protocols and reducing implementation complexity.

The secondary link establishment and transmission module 1002 may also be configured to transmit a target data packet over either a first communication channel or a second communication channel. The first communication channel serves to identify the secondary device, while the second communication channel is used for synchronization. In this way, each of the secondary devices may align its clock with that of the master device, mitigating clock drift and ensuring that the relative timing of transmission slots across the DBIS links remains stable.

In one embodiment, the device 1000 further comprises a decoding and playback module. This module is configured to decode each secondary broadcast data packet received over the secondary communication links to obtain corresponding audio content, and either down-mix this audio into a mono signal for playback or maintain and play it as separate channels in a multi-channel configuration. This supports flexible adaptation to both mono-channel and multi-channel audio output configurations.

The primary broadcast communication link may be implemented as a primary broadcast isochronous stream (PBIS) link, while each secondary broadcast communication link may be implemented as a secondary broadcast isochronous stream (SBIS) link. The collective of such links forms a distributed broadcast isochronous group (DBIG). The set link used to coordinate the distributed transmitter set may be implemented as a bidirectional periodic advertising link or a BLE ACL link.

In one embodiment, the audio content carried in the primary broadcast data packet and in each secondary broadcast data packet within an isochronous interval may differ, enabling concurrent transmission of distinct audio streams by different devices in the set.

Additionally, the secondary link establishment and transmission module 1002 may be configured to transmit an auxiliary synchronization PDU over a periodic advertising channel. This auxiliary synchronization PDU contains link information for the broadcast communication link group and allows one or more listener devices to synchronize with the master device and subsequently receive audio data from both the primary and secondary broadcast communication links based on that link information.

The device 1000, as described, supports the implementation of all operations performed by the master device in accordance with the wireless audio data transmission method of the present invention. To avoid unnecessary repetition, detailed processes corresponding to the method embodiments are not restated here.

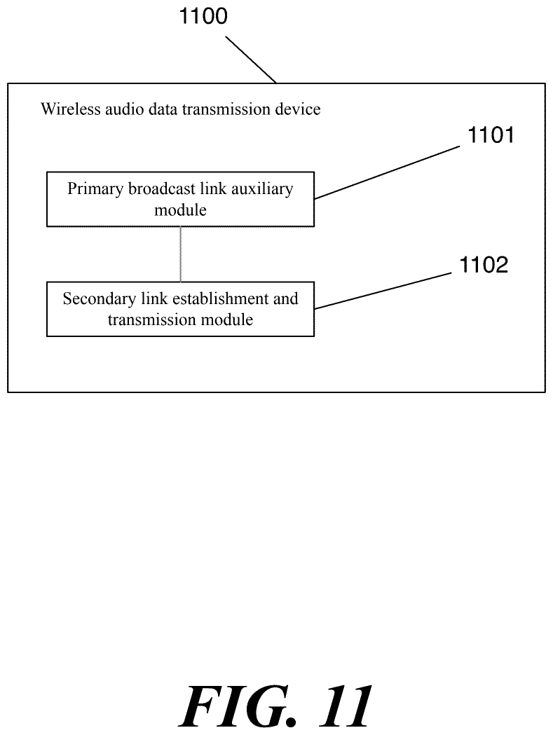

A wireless audio data transmission device 1100 applied to a first secondary device is provided in accordance with an embodiment of the present invention. As shown in FIG. 11, the device 1100 comprises a primary broadcast link auxiliary module 1101, which is configured to establish a primary broadcast communication link with a master device, and a secondary broadcast link establishment and transmission module 1102, which is configured to establish a secondary broadcast communication link through the master device.

Within one isochronous interval of a sequence of consecutive isochronous intervals, the device 1100 is configured to receive a primary broadcast data packet transmitted by the master device via the primary broadcast communication link and to transmit a corresponding secondary broadcast data packet via the secondary broadcast communication link. Additionally, the device 1100 may receive a secondary broadcast data packet from a second secondary device via a corresponding secondary broadcast communication link. The time slots allocated for broadcasting the primary and secondary broadcast data packets within the same isochronous interval are arranged such that they do not overlap.

In one embodiment, the primary broadcast communication link and the respective secondary broadcast communication links form a broadcast communication link group. The master device and the associated secondary devices collectively constitute a distributed transmitter set, which is formed and coordinated via a set link. Within this configuration, the secondary broadcast link establishment and transmission module 1102 is operable to receive a DTS synchronization search data packet transmitted by the master device via the set link and to respond with a DTS synchronization set request data packet. This request packet includes request link information comprising a device address and a device identifier corresponding to the first secondary device.

Upon determining that the first secondary device is permitted to join the distributed transmitter set, the master device transmits a DTS synchronization set configuration packet carrying link information for the broadcast communication link group and a target identifier. The secondary broadcast link establishment and transmission module 1102 then generates and transmits a DTS synchronization set response packet in response to the configuration packet. The first secondary device is thus designated as a secondary device within the distributed transmitter set and establishes the corresponding secondary broadcast communication link based on the provided link information. The target identifier uniquely identifies the assigned secondary broadcast communication link within the broadcast communication link group.

In one embodiment, the primary broadcast communication link is implemented as a primary broadcast isochronous stream (PBIS) link, the secondary broadcast communication link is implemented as a secondary broadcast isochronous stream (SBIS) link, and the broadcast communication link group is implemented as a distributed broadcast isochronous group (DBIG).

In one embodiment, the set link used to facilitate the coordination between the master and secondary devices is implemented as either a bidirectional periodic advertising link or a BLE ACL link. The wireless audio data transmission device 1100, as described above, is capable of executing the processes associated with a secondary device as described in the corresponding embodiments of the wireless audio data transmission method. To avoid unnecessary duplication, those details are not repeated here, in accordance with an embodiment of the present invention.

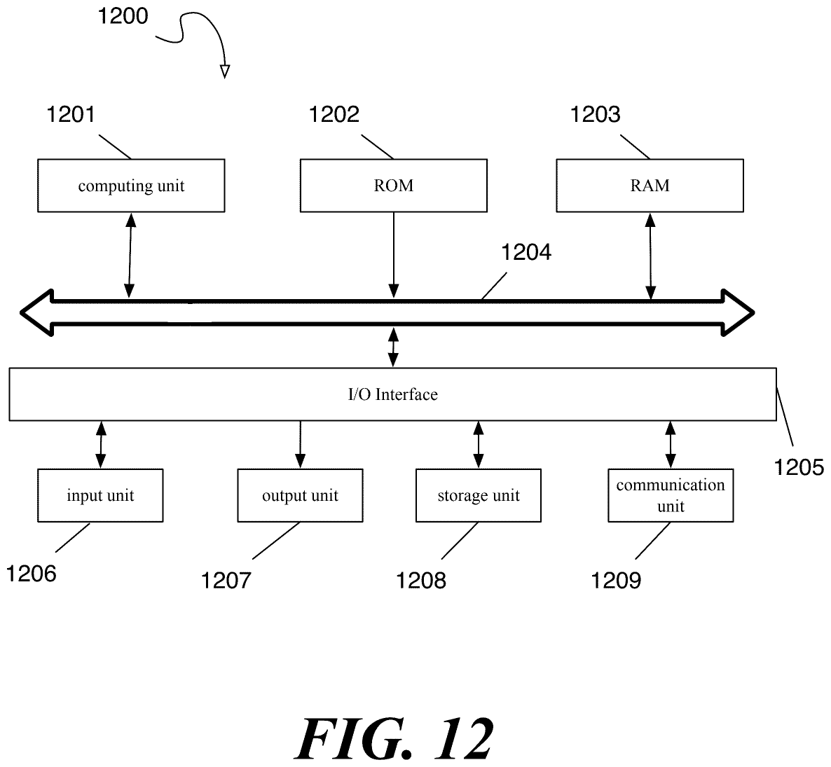

An electronic device and a computer-readable storage medium are provided in accordance with an embodiment of the present invention. FIG. 12 illustrates a schematic block diagram of an example electronic device 1200 that may be used to implement the wireless audio data transmission methods described herein. The device 1200 includes a computing unit 1201 configured to execute various operations and processes in accordance with a computer program stored in a read-only memory (ROM) 1202 or loaded from a storage unit 1208 into a random-access memory (RAM) 1203. The RAM 1203 may also store data and programs necessary for runtime execution. The computing unit 1201, ROM 1202, and RAM 1203 are interconnected via a bus 1204, to which an input/output (I/O) interface 1205 is also connected.

The I/O interface 1205 is further connected to various components, including an input unit 1206 (e.g., a keyboard or mouse), an output unit 1207 (e.g., a display or speaker), the storage unit 1208 (e.g., a magnetic or optical disc), and a communication unit 1209 (e.g., a network card, modem, or wireless transceiver). The communication unit 1209 enables the device 1200 to exchange data with other devices via the Internet and/or other telecommunications networks.

The computing unit 1201 may be implemented using general-purpose or special-purpose processors capable of handling computational and control tasks. Examples include, but are not limited to, a central processing unit (CPU), graphics processing unit (GPU), artificial intelligence (AI) accelerators, machine learning processors, digital signal processors (DSPs), or microcontrollers. The computing unit 1201 is configured to perform the wireless audio data transmission methods described herein, such as those described in conjunction with FIG. 1 or FIG. 7.

In some embodiments, the methods described herein may be implemented as software instructions stored in a computer-readable storage medium, such as the storage unit 1208. These instructions may be loaded into RAM 1203 and executed by the computing unit 1201. Alternatively, in other embodiments, the computing unit 1201 may be configured to execute the methods via firmware or other hardware-assisted mechanisms.

A computer program product is also provided in accordance with an embodiment of the present invention. The computer program product comprises executable instructions which, when run by a processor, implement the steps of the method embodiments described herein and achieve the same technical effects, in accordance with an embodiment of the present invention.

Related technologies based on the Broadcast Isochronous Group (BIG) protocol support point-to-multipoint wireless broadcast audio (WBA). However, existing BIG-based systems lack synchronization mechanisms when deployed in multipoint-to-multipoint scenarios, such as multi-microphone audio broadcasts or performances involving multiple wireless instruments. As each transmitting device operates independently, timing drift between transmission slots can occur, leading to overlapping or asynchronous audio signals, thereby hindering synchronized reception at the receiving devices.

To address this issue, a wireless audio data transmission method is provided in accordance with an embodiment of the present invention. The method applies to a transmitting device cluster comprising a master transmitting device and a plurality of slave transmitting devices synchronized with the master. These devices collectively broadcast to N receiving devices in continuous isochronous intervals, where M and N are positive integers.

During any isochronous interval, the master transmitting device transmits a first broadcast data packet to the receiving devices using a first communication link group, while each slave transmitting device transmits a respective second broadcast data packet using a corresponding second communication link group. The time slots and/or frequency domain channels allocated to each of these broadcast data packets are non-overlapping within the same isochronous interval, thereby preventing interference or desynchronization.

This configuration enables the receiving devices to synchronously receive and decode distinct audio data from multiple transmitting devices using either time-division or frequency-division multiplexing. If frequency domain separation is employed, receiving devices must support simultaneous reception across multiple channels. However, if time division is used, devices can function with single-channel receivers, improving the method's adaptability across various hardware implementations.

The method described herein is well suited to multipoint-to-multipoint WBA applications, such as live broadcasts featuring multiple simultaneous speakers or performers using separate wireless microphones or instruments, in accordance with an embodiment of the present invention.

In one embodiment, among the first broadcast data packet and the second broadcast data packets transmitted within any given isochronous interval, each broadcast data packet carries different audio data. This allows distinct audio streams to be transmitted concurrently by multiple devices in a synchronized manner.

In another embodiment, the method further comprises operations for expanding the transmitting device cluster. Specifically, the master transmitting device transmits a synchronization cluster search packet on a first advertising channel. A candidate transmitting device, upon receiving the synchronization cluster search packet, feeds back a synchronization cluster request packet. The request packet carries request link information, which includes a device address and a device identifier of the candidate transmitting device.

If the master transmitting device determines, based on the device address and device identifier, that the candidate device is permitted to join the transmitting device cluster, it transmits a synchronization cluster configuration packet to the candidate transmitting device. This packet contains configuration link information for establishing communication within the cluster. The master device then receives a synchronization cluster response packet transmitted by the candidate device in reply to the configuration packet. Upon successful reception, the candidate device is designated as a slave transmitting device, and a second communication link group is established between the new slave transmitting device and the receiving devices, as defined by the configuration link information.

Further, the master transmitting device transmits a broadcast isochronous cluster auxiliary synchronization packet on a second advertising channel. This packet includes central link information corresponding to the first communication link group, and auxiliary link information corresponding to each of M second communication link groups. The broadcast isochronous cluster auxiliary synchronization packet enables receiving devices to synchronize with the master transmitting device, receive the first broadcast data packet over the first communication link group, and receive second broadcast data packets from the slave transmitting devices over the corresponding second communication link groups.

By defining and utilizing the synchronization cluster search, request, configuration, and response packets, a structured procedure is established to convert a candidate transmitting device into a slave transmitting device. This conversion completes the operation of expanding the transmitting device cluster. It should be noted that each second communication link group corresponding to a newly added slave transmitting device is set and managed by the master transmitting device based on information contained in the synchronization cluster response packet. In this manner, the communication link groups within the cluster—including the first and all second communication link groups—are uniformly configured and managed by the master device. This centralized configuration ensures synchronization across the cluster and guarantees that the broadcast data packets transmitted over the respective communication link groups during the same isochronous interval occupy either non-overlapping time slots or non-overlapping frequency domain channels.

Additionally, by defining and configuring the broadcast isochronous cluster auxiliary synchronization packet, the communication link information of all devices within the transmitting device cluster is aggregated into a single broadcast packet. This design simplifies reception and parsing by the receiving devices, which need only extract the aggregated communication link information from a single packet to synchronize with the entire cluster.

In this architecture, the master transmitting device functions as a coordination node between the M slave transmitting devices and the N receiving devices. On one hand, the master device centrally manages the multiple communication links within the cluster. On the other hand, it distributes communication link information to the receiving devices via a point-to-multipoint broadcast channel. This configuration supports the construction of a composite communication link set capable of robust multipoint-to-multipoint wireless broadcast communication.

In one example, the first communication link group and each second communication link group are implemented as Bluetooth Low Energy (BLE) Audio Broadcast Isochronous Group (BIG) links. The first and second advertising channels used for transmitting the various synchronization and configuration packets are both periodic broadcast channels, in accordance with an embodiment of the present invention.

In one embodiment, the central link information comprises P enable parameters, each of which corresponds one-to-one with an auxiliary communication link group. The value of each enable parameter indicates whether the corresponding auxiliary communication link group is enabled. Here, P is an integer greater than or equal to M, where M represents the number of slave transmitting devices. Each second communication link group corresponds to one of the enabled auxiliary communication link groups. By defining and applying these enable parameters, the master transmitting device is capable of more flexible and dynamic management of the slave transmitting devices, including selectively enabling or disabling communication links as needed.

In one embodiment, the broadcast isochronous cluster auxiliary synchronization packet is formatted according to the common extended advertising payload format, consistent with Bluetooth Low Energy (BLE) specifications. The extended header of this packet carries the central link information, and the enable parameters occupy part or all of the bits in a reserved field within the central link information.

Exemplarily, the broadcast isochronous cluster auxiliary synchronization packet may be defined as a BIC_AUX_SYNC_IND protocol data unit (PDU). The synchronization cluster search packet may be defined as a BIC_SYNC_CLUSTER_SEARCH PDU, the synchronization cluster request packet as a BIC_SYNC_CLUSTER_REQ PDU, the synchronization cluster configuration packet as a BIC_SYNC_CLUSTER_CONFIG PDU, and the synchronization cluster response packet as a BIC_SYNC_CLUSTER_RSP PDU. Each of these packets participates in the establishment and management of communication links within the broadcast communication link group.

The first communication link group is referred to as a Central BIG (CBIG) link, while each second communication link group is referred to as an Assisted BIG (ABIG) link. The master transmitting device transmits audio data over the CBIG link, and each slave transmitting device transmits its audio data over a corresponding ABIG link. The ABIG link is established between the master and the slave transmitting device via a Bidirectional Periodic Advertising (BPA) link. Once established, the CBIG and ABIG links together form a Broadcast Isochronous Cluster (BIC) link, enabling coordinated transmission of multi-channel audio in accordance with an embodiment of the present invention.

The BIC_AUX_SYNC_IND protocol data unit (PDU) is structured similarly to the AUX_SYNC_IND PDU defined in the Bluetooth Low Energy (BLE) protocol, with both adopting the Common Extended Advertising Payload Format, as illustrated in FIG. 2 in accordance with an embodiment of the present invention. This format comprises a 6-bit extended header length field, a 2-bit advertising mode (AdvMode), a variable-length extended header (ranging from 0 to 63 bytes), and an advertising data (AdvData) field of up to 254 bytes.

As further shown in FIG. 3, the extended header may include fields such as the Extended Header Flags, the advertiser address (AdvA), the target address (TargetA), Constant Tone Extension information (CTEInfo), Advertising Data Information (ADI), auxiliary advertising pointer (AuxPtr), synchronization information (SyncInfo), transmission power (TxPower), and Additional Controller Advertising Data (ACAD). The Extended Header Flags are bitwise indicators, illustrated in FIG. 4, with each bit corresponding to one field in the extended header—where a bit value of 1 indicates the field is present, and 0 indicates absence.

The AdvA field provides the address of the transmitting device, while the TargetA identifies the intended recipient. Other fields such as CTEInfo and ACAD provide auxiliary control and metadata information relevant to extended advertising behavior. In related technologies, the AUX_SYNC_IND PDU includes BIG link information (BIG Info) via the ACAD field, which also reserves an 8-bit section for future use (RFU).

In the present invention, the BIC_AUX_SYNC_IND PDU carries Central BIG (CBIG) link information—also referred to herein as central link information—via the ACAD field. A reserved field within this central link information contains a set of Assisted BIG (ABIG) link enable bits, designated ABIG_EN_1 through ABIG_EN_M, corresponding to a one-to-one mapping with available ABIG links. A bit set to 1 indicates that the corresponding ABIG link is enabled; a bit set to 0 indicates it is disabled or not in use. When a bit is set to 1, the AdvData field of the BIC_AUX_SYNC_IND PDU carries the ABIG link information (ABIG Info) associated with that sequence number. This ABIG Info shares the same structure as the BIG Info defined in the BLE protocol, providing necessary parameters for receiving devices such as the start time, number of BIS links, link interval, access address, and retransmission settings.

The ABIG Infos are arranged sequentially in the AdvData, where ABIG1 Info corresponds to the first enabled ABIG link, and ABIGM Info corresponds to the M-th. Similar to the CBIG Info, each ABIG Info instance provides essential configuration parameters to allow listener devices to synchronize with and receive from the ABIG links.

Other cluster management PDUs—namely, BIC_SYNC_CLUSTER_SEARCH, BIC_SYNC_CLUSTER_REQ, BIC_SYNC_CLUSTER_CONFIG, and BIC_SYNC_CLUSTER_RSP—also conform to the extended advertising payload format illustrated in FIG. 2. While structurally similar to the BIC_AUX_SYNC_IND PDU, these differ in the contents of their extended headers, the selected AdvMode, and the composition of their AdvData.

The BIC_SYNC_CLUSTER_SEARCH PDU, for instance, sets bit 0 of the Extended Header Flags to 1, indicating that the extended header includes the AdvA field, which contains the address of the master transmitting device. Other fields are consistent with the BIC_AUX_SYNC_IND PDU: the ACAD includes CBIG Info, ABIG enable bits reflect the state of established ABIG links, and the AdvData includes the ABIG Info of those links. The AdvMode is set to 0b01, denoting the “Undirected Clustering Available” type. This packet serves dual purposes: it allows the master device to advertise its configuration to nearby candidate transmitting devices, and it enables discovery and initialization of clustering procedures.

In contrast, the BIC_SYNC_CLUSTER_REQ PDU sets bits 0 and 1 of the Extended Header Flags to 1, including both AdvA and TargetA fields—the former being the address of the candidate transmitting device, and the latter being that of the master device. This PDU omits both the CBIG Info and ABIG Info from the ACAD and AdvData fields, respectively. Its AdvMode is set to 0b11, indicating a “Clustering Request” type. The AdvData may contain identifying information such as the device name or a universally unique identifier (UUID), which can serve as the device identifier referenced during clustering. This request initiates a join operation by a candidate device, signaling the master device to evaluate whether to accept the new ABIG link.

Each of these PDUs plays a critical role in establishing and maintaining coordinated transmission behavior within a Broadcast Isochronous Cluster (BIC), in accordance with an embodiment of the present invention.

The BIC_SYNC_CLUSTER_CONFIG PDU differs from the BIC_AUX_SYNC_IND PDU in that bits 0 and 1 of the Extended Header Flags are both set to 1, indicating that the extended header includes both the AdvA and TargetA fields. In this context, the AdvA represents the device address of the master transmitting device, and the TargetA represents the device address of the slave transmitting device. Apart from this difference, the remaining fields of the BIC_SYNC_CLUSTER_CONFIG PDU align with those of the BIC_AUX_SYNC_IND PDU. Specifically, the ACAD field contains the CBIG Info for the CBIG link, and the ABIG link enable bits embedded within the CBIG Info indicate the status of the currently established ABIG links. Additionally, the AdvData field carries the ABIG Info of the established ABIG links. The AdvMode is set to 0b10, which signifies a “Directed Clustering Available” type.

The BIC_SYNC_CLUSTER_CONFIG PDU is employed by the master transmitting device not only to convey the existing CBIG and ABIG configuration to the candidate slave transmitting device but also to configure the ABIG Info necessary for establishing a new ABIG link specific to that device. Notably, the ABIG Info carried in this configuration PDU reflects the confirmed configuration, which may differ from the ABIG Info initially proposed by the candidate device in the earlier BIC_SYNC_CLUSTER_REQ PDU. This distinction reflects the hierarchical control exercised by the master transmitting device, which ultimately assigns the ABIG Info used by the slave device. Once the candidate device successfully receives the BIC_SYNC_CLUSTER_CONFIG PDU, it is formally designated as a slave transmitting device within the cluster.

The BIC_SYNC_CLUSTER_RSP PDU also sets both bits 0 and 1 of the Extended Header Flags, including both the AdvA and TargetA fields. In this case, the AdvA identifies the slave transmitting device, while the TargetA refers to the master transmitting device. Unlike the BIC_AUX_SYNC_IND or BIC_SYNC_CLUSTER_CONFIG PDUs, the BIC_SYNC_CLUSTER_RSP PDU does not include CBIG Info in the ACAD field nor ABIG Info in the AdvData field. The remaining fields, however, follow the same structure as the BIC_AUX_SYNC_IND PDU. The AdvMode is set to 0b00, indicating a “Clustering Response” type. This PDU is transmitted by the slave transmitting device in response to the configuration provided by the master device and serves to confirm successful joining of the BIC link and the establishment of the corresponding ABIG link.

In operation, a receiving device begins synchronization with the master transmitting device by first detecting the ADV_EXT_IND PDU on the primary advertising channel, followed by reception of the AUX_ADV_IND PDU on the secondary advertising channel. Subsequently, the receiving device may receive the BIC_AUX_SYNC_IND PDU on the second advertising channel, or alternatively, receive either the BIC_SYNC_CLUSTER_SEARCH PDU or the BIC_SYNC_CLUSTER_CONFIG PDU on the first advertising channel. From these packets, the receiving device extracts the CBIG Info, determines the enabled ABIG links, and retrieves the relevant ABIG Info, allowing it to receive the broadcast isochronous stream (BIS) PDUs and associated audio data from both the CBIG and ABIG links.

Similarly, a candidate transmitting device undergoes a synchronization process with the master transmitting device. This involves receiving the ADV_EXT_IND PDU on the primary advertising channel, followed by the AUX_ADV_IND PDU on the secondary advertising channel, and then receiving either the BIC_AUX_SYNC IND, BIC_SYNC_CLUSTER_SEARCH, or BIC_SYNC_CLUSTER_CONFIG PDU on the periodic advertising channels. Upon synchronization, the candidate transmitting device exchanges the BIC_SYNC_CLUSTER_SEARCH, BIC_SYNC_CLUSTER_REQ, BIC_SYNC_CLUSTER_CONFIG, and BIC_SYNC_CLUSTER_RSP PDUs with the master transmitting device, thereby completing the process of joining the BIC link and establishing its own ABIG link in accordance with an embodiment of the present invention.

The communication link established through the exchange of the above-described PDUs between the master transmitting device and the candidate slave transmitting device is referred to as a Bidirectional Periodic Advertising (BPA) link. In an exemplary embodiment, the master transmitting device may enter a BIC establishment mode, either automatically or through a user interface (UI). Upon entering this mode, the master transmitting device begins transmitting the BIC_SYNC_CLUSTER_SEARCH PDU on the first advertising channel.

Candidate transmitting devices that wish to join the BIC link of the master transmitting device—identified by a specific device address—listen for the BIC_SYNC_CLUSTER_SEARCH PDU. Upon reception, and after an inter-frame space (T_IFS), which may be 150 μs or a value defined by the BLE protocol, each candidate device replies with a BIC_SYNC_CLUSTER_REQ PDU. This PDU represents a request to establish an ABIG link and join the BIC link.

When the master transmitting device receives the BIC_SYNC_CLUSTER_REQ PDU, it evaluates the request based on one or more parameters such as the device address, device name, or a Universally Unique Identifier (UUID) of the candidate device. If permitted, the master transmitting device transmits a BIC_SYNC_CLUSTER_CONFIG PDU to the candidate device at the corresponding address. Upon receiving this configuration PDU, the candidate transmitting device—now designated as a slave transmitting device—replies with a BIC_SYNC_CLUSTER_RSP PDU after an interval of T_IFS, thereby confirming its intent to join the BIC link.

If the master transmitting device does not receive a BIC_SYNC_CLUSTER_RSP PDU in response, it continues retransmitting the BIC_SYNC_CLUSTER_CONFIG PDU until a valid response is received or a timeout occurs. Once the slave transmitting device transmits the BIC SYNC_CLUSTER_RSP PDU, it proceeds to establish the ABIG link according to the ABIG Info contained in the previously received BIC_SYNC_CLUSTER_CONFIG PDU.

It should be emphasized that only the candidate transmitting device addressed in the BIC_SYNC_CLUSTER_CONFIG PDU is permitted to respond with the BIC_SYNC_CLUSTER_RSP PDU after the prescribed interval. Additionally, the ABIG Info configured by the master device in the BIC_SYNC_CLUSTER_CONFIG PDU may differ from the ABIG Info initially proposed by the candidate device in its BIC_SYNC_CLUSTER REQ PDU. In particular, the ABIG Offset value is determined and allocated by the master transmitting device to ensure non-overlapping time slot assignments across ABIG links.

To reduce the likelihood of transmission collisions, candidate transmitting devices are required to introduce a randomized delay before responding. After receiving the initial BIC_SYNC_CLUSTER_SEARCH PDU and synchronizing with the master device, each candidate device waits a randomly selected number of BIC isochronous intervals (ISO Intervals) before attempting to transmit its BIC_SYNC_CLUSTER_REQ PDU. The transmission occurs only after the candidate device receives the BIC_SYNC_CLUSTER_SEARCH PDU again following the delay, thereby mitigating interference from simultaneous responses and ensuring orderly establishment of ABIG links.

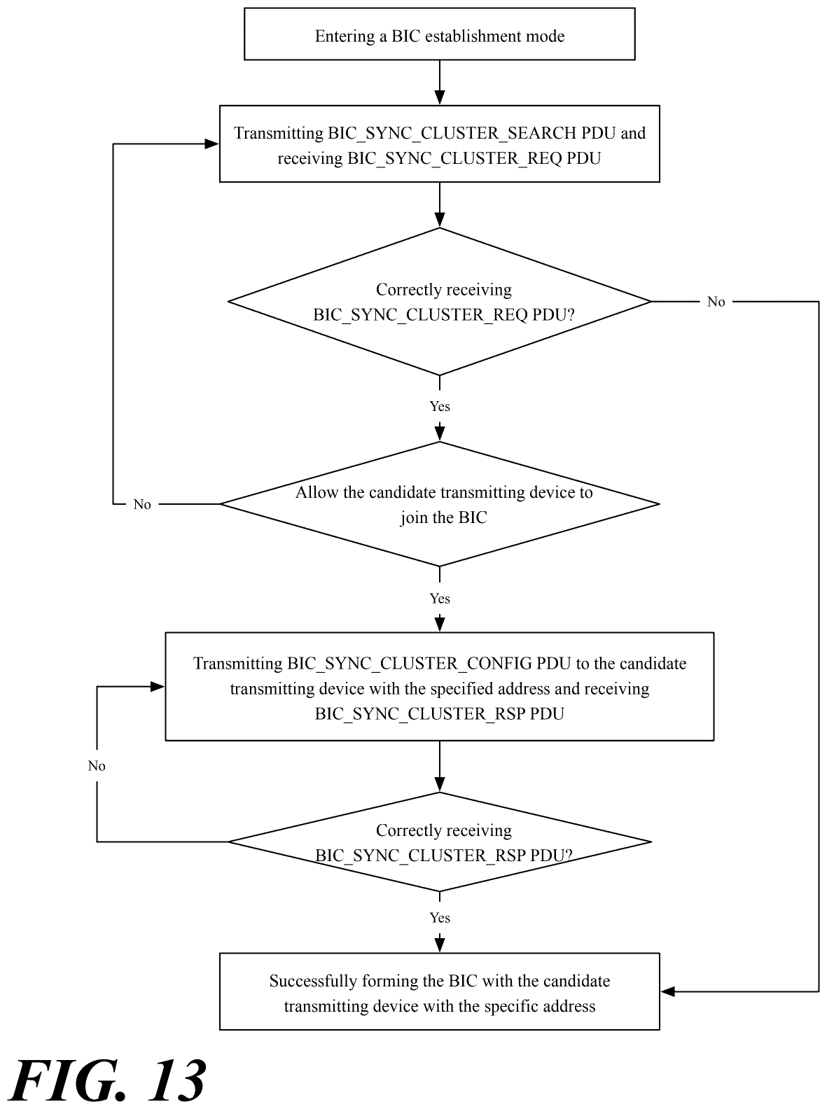

As illustrated in FIG. 13, a process is provided whereby the master transmitting device establishes or extends a Broadcast Isochronous Cluster (BIC) by allowing candidate transmitting devices to join. Upon entering a BIC establishment mode, the master transmitting device begins by transmitting a BIC_SYNC_CLUSTER_SEARCH PDU and awaits a corresponding BIC_SYNC_CLUSTER_REQ PDU from a candidate transmitting device. If the master device does not receive a valid BIC_SYNC_CLUSTER_REQ PDU, it continues broadcasting the BIC_SYNC_CLUSTER_SEARCH PDU to solicit responses.

Once a valid BIC_SYNC_CLUSTER_REQ PDU is received and the candidate transmitting device is determined to be eligible-based, for example, on the device address or identifier-the master transmitting device transmits a BIC_SYNC_CLUSTER_CONFIG PDU directed to the candidate device. The master device then waits for a BIC_SYNC_CLUSTER_RSP PDU in response. If no response is received, the master device retransmits the BIC_SYNC_CLUSTER_CONFIG PDU until the BIC_SYNC_CLUSTER_RSP PDU is successfully received or a timeout occurs.

Upon receiving the BIC_SYNC_CLUSTER_RSP PDU from the candidate device, the BIC is considered successfully formed or extended to include that device. The master transmitting device then continues to transmit additional BIC SYNC_CLUSTER_SEARCH PDUs to discover and configure further candidate devices through the same procedure. This process is repeated until the BIC has incorporated the desired number of slave transmitting devices.

Once the expected number of slave transmitting devices have joined the BIC, the master transmitting device exits the BIC establishment mode. At this point, it ceases transmission of the BIC_SYNC_CLUSTER_SEARCH PDU on the first advertising channel and begins transmitting the BIC_AUX_SYNC_IND PDU on the second advertising channel. The transmission of this auxiliary synchronization packet enables receiving devices to synchronize with the BIC master device and obtain the CBIG Info and ABIG Info necessary to receive audio data streams via the respective communication links.

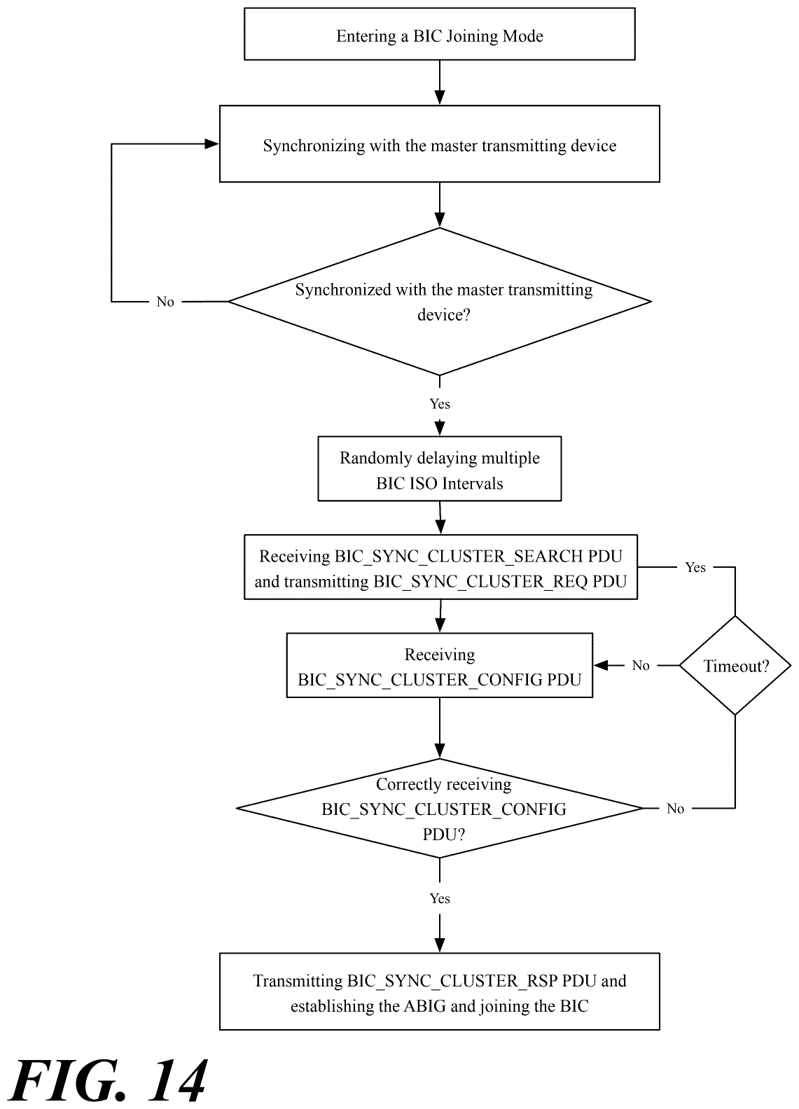

As illustrated in FIG. 14, a process is provided by which a candidate transmitting device establishes an Assisted Broadcast Isochronous Group (ABIG) link and joins a Broadcast Isochronous Cluster (BIC). Upon entering a BIC joining mode, the candidate transmitting device first synchronizes with the master transmitting device. This synchronization is achieved by sequentially receiving an ADV_EXT_IND PDU on the primary advertising channel, followed by an AUX_ADV_IND PDU on the secondary advertising channel, and subsequently a BIC_SYNC_CLUSTER_SEARCH PDU transmitted by the master transmitting device on the first advertising channel.

Once synchronization is completed, to avoid collisions that could result from multiple candidate transmitting devices attempting to transmit BIC_SYNC_CLUSTER_REQ PDUs simultaneously, the candidate transmitting device introduces a randomized delay spanning multiple BIC isochronous intervals. Upon receiving the BIC_SYNC_CLUSTER_SEARCH PDU again, the candidate device transmits the BIC_SYNC_CLUSTER_REQ PDU after a time interval defined as T_IFS. For improved robustness, the candidate transmitting device may receive multiple BIC_SYNC_CLUSTER_SEARCH PDUs and transmit its request within several such intervals, thereby reducing the likelihood of packet collisions.

Following this, the candidate transmitting device receives the BIC_SYNC_CLUSTER_CONFIG PDU sent by the master transmitting device. If the packet is received correctly, the candidate device replies with a BIC_SYNC_CLUSTER_RSP PDU after an interval of T_IFS to confirm establishment of the ABIG link and to formally join the BIC. If the configuration packet is not received correctly, the candidate device continues to await the BIC_SYNC_CLUSTER_CONFIG PDU until a timeout occurs. Upon timing out, the device resumes the process by receiving a subsequent BIC_SYNC_CLUSTER_SEARCH PDU and reinitiating the request cycle until it successfully establishes the ABIG link and joins the BIC.

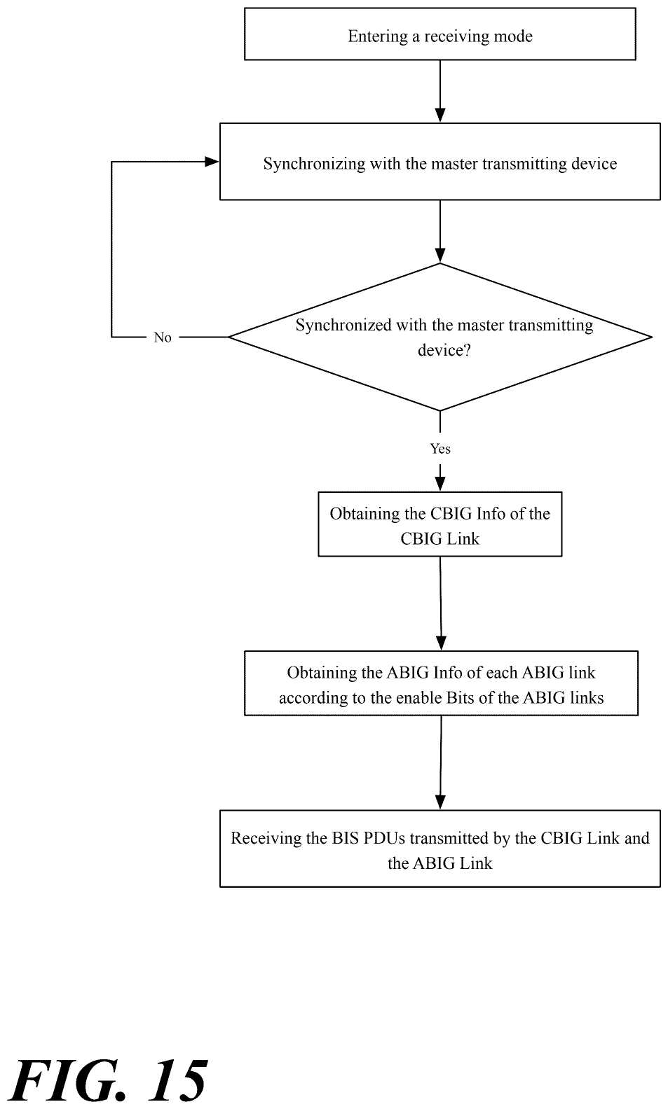

Referring now to FIG. 15, a workflow is shown for a receiving device entering a receiving mode. In this state, the receiving device performs synchronization with the master transmitting device in a similar fashion: by receiving, in order, the ADV_EXT_IND PDU on the primary advertising channel, the AUX_ADV_IND PDU on the secondary advertising channel, and the BIC_AUX_SYNC_IND PDU on the second advertising channel—or alternatively, the BIC_SYNC_CLUSTER_SEARCH and BIC_SYNC_CLUSTER_CONFIG PDUs transmitted on the first advertising channel.

The aforementioned primary and secondary advertising channels cooperate with the first and second advertising channels to facilitate delivery of the relevant synchronization and configuration packets. A receiving device can only complete synchronization upon correctly receiving both the ADV_EXT_IND and AUX_ADV_IND PDUs. Once synchronized, the receiving device parses the CBIG Info embedded in the relevant PDUs to determine which ABIG links are enabled, using the enable bits therein. It then obtains the ABIG Info corresponding to each enabled ABIG link, allowing it to receive Broadcast Isochronous Stream (BIS) PDUs from both the CBIG and ABIG links and extract the associated audio data.

In one embodiment, the timing structure of the BIC link is further defined such that each isochronous interval comprises multiple repeating time slots. For example, any two consecutive isochronous intervals—referred to as the first and second isochronous intervals—maintain consistent time slot assignments. The time slot occupied by the primary broadcast data packet in the first isochronous interval is the same as the time slot it occupies in the second. Similarly, for any given secondary broadcast data packet, its time slot in the first isochronous interval is the same as in the second. This fixed slot structure helps avoid slot reconfiguration errors and reduces the processing overhead associated with dynamically assigned transmission times. As a result, this configuration supports stable, scalable, and synchronized multipoint wireless audio transmission in accordance with an embodiment of the present invention.

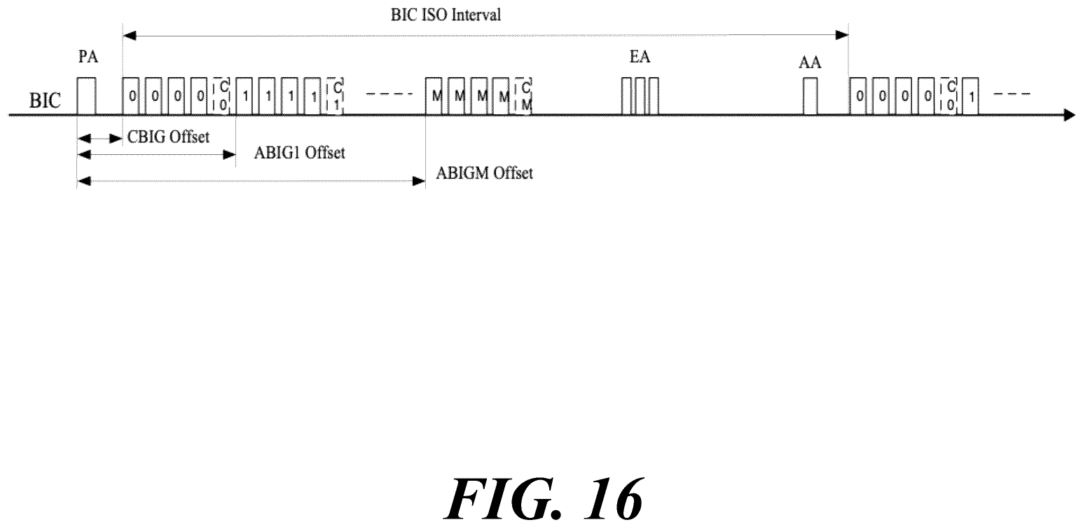

In one example, the time slot structure of a BIC link in which the CBIG link and the ABIG links occupy non-overlapping time slots is illustrated in FIG. 16. In this example, the BIC link is composed of one Central BIG (CBIG) link and M Assisted BIG (ABIG) links, where M is a positive integer. The overall communication period is divided into isochronous intervals, each having a length defined by the BIC ISO Interval.

Within a given BIC ISO Interval, a time slot labeled “0” designates the period during which the CBIG link transmits BIS PDUs, while a slot labeled “C0” (shown as a dashed box in FIG. 16) optionally indicates transmission of a BIG Control PDU for the CBIG link. Similarly, slots labeled “1”, “2”, up to “M” designate respective time slots for ABIG1 through ABIGM links to transmit their BIS PDUs, and corresponding slots labeled “C1” through “CM” indicate optional BIG Control PDU transmissions by each ABIG link.

Synchronization among these links is maintained by using a shared set of advertising PDUs, which include an ADV_EXT_IND PDU (denoted as EA in FIG. 16) on the primary advertising channel, an AUX_ADV_IND PDU (denoted as AA) on the secondary advertising channel, and either a BIC_AUX_SYNC_IND, BIC_SYNC_CLUSTER_SEARCH, or BIC_SYNC_CLUSTER_CONFIG PDU (denoted as PA) transmitted on the second or first advertising channel. Each of these PDUs supports synchronization by conveying CBIG Info and relevant ABIG Info to participating devices.

According to the configuration shown in FIG. 16, the CBIG Offset value carried in the CBIG Info is smaller than the offset values assigned to the ABIG links, such that the CBIG link transmits its BIS PDUs first in each interval, followed in sequence by the ABIG links. This arrangement ensures a consistent time division among the links. However, in other implementations, the relative order of offsets may differ, and in some cases, an ABIG Offset may precede the CBIG Offset.

In one embodiment, a target slave transmitting device synchronizes its internal clock by

referencing a target packet transmitted by the master transmitting device. This target packet may be transmitted on the first advertising channel, which is used primarily to identify slave transmitting devices, or on the second advertising channel, which supports synchronization. The synchronization cluster search packet and the synchronization cluster configuration packet are transmitted on the first advertising channel, while the broadcast isochronous cluster auxiliary synchronization packet is transmitted on the second advertising channel.

Each of these packets carries CBIG Info that includes the status of established ABIG links, represented by ABIG link enable bits, and further contains the ABIG Info for each enabled ABIG link. By continually receiving these packets, the slave transmitting devices are able to dynamically adjust their clocks, thereby maintaining alignment with the master transmitting device or preserving their configured ABIG Offsets. This temporal alignment ensures the relative stability of the time slot structure between CBIG and ABIG links, prevents unintended slot overlap due to clock drift, and thereby avoids audio desynchronization between transmitting devices in the BIC link, in accordance with an embodiment of the present invention.

In accordance with one embodiment of the present invention, a wireless audio data transmission system is provided, referred to as a Multi-Source Wireless Broadcast Audio (MSWBA) system. The MSWBA system includes one MSWBA transmitting device and one or more MSWBA receiving devices. The MSWBA transmitting device comprises a master transmitting device, referred to as the MSWBA master transmitting device, and at least one slave transmitting device, referred to as the MSWBA slave transmitting device.

The MSWBA system employs a Broadcast Isochronous Cluster (BIC) link for audio data transmission between the transmitting and receiving devices. The BIC link consists of a Central BIG (CBIG) link and one or more Assisted BIG (ABIG) links. The MSWBA master transmitting device transmits audio via the CBIG link, while the MSWBA slave transmitting devices transmit via respective ABIG links. Each ABIG link is established through a Bidirectional Periodic Advertising (BPA) link between the MSWBA master and slave transmitting devices, thereby forming the complete BIC link.

For ease of reference, the MSWBA transmitting device may also be referred to as a BIC master device, while the MSWBA receiving device may be referred to as a BIC slave device. Similarly, the MSWBA master transmitting device may be referred to as a CBIG master device, and the MSWBA slave transmitting device may be referred to as an ABIG master device. The BIC master device encompasses both the CBIG and ABIG master devices, while the BIC slave device functions as a CBIG and ABIG slave device.

As an illustrative example, consider a scenario involving two wireless microphones and multiple wireless headphones. The MSWBA transmitting device includes a master wireless microphone and a slave wireless microphone, while the MSWBA receiving devices are wireless headphones. The BIC link in this case consists of a CBIG link and one ABIG link (referred to as ABIG1). The master microphone transmits audio data over the CBIG link, and the slave microphone transmits over the ABIG1 link.

As shown in FIG. 16, the time slot structure of the BIC link is defined such that the CBIG and ABIG links do not overlap. In this example, the CBIG link transmits LC3-encoded mono audio sampled at 48 KHz with a frame length of 10 ms, a coding rate of 96 kbps, and an SDU size of 120 bytes. The isochronous interval (ISO Interval) is 20 ms, with a BIS link count of 1, NSE of 6, BN of 2, IRC of 3, and PTO of 0. The BIS PDU occupies a 700 μs airtime slot using the BLE 2 Mbps physical layer. Periodic advertising occurs every 60 ms, with a CBIG Offset of 1.23 ms relative to the advertising start. These parameters are carried in the CBIG Info.

The ABIG1 link is configured with matching parameters, except for its ABIG1 Offset and Seed Access Address. In this example, the ABIG1 Offset is set to 6.15 ms, ensuring no time slot overlap between the ABIG1 and CBIG links. This configuration is included in the ABIG1 Info.

The establishment of the BIC link by the master and slave wireless microphones follows the procedures described in FIG. 13 and FIG. 14. Upon successful formation of the BIC link, the master microphone transmits a BIC_AUX_SYNC_IND PDU that sets the lowest ABIG enable bit in the CBIG Info to 1 and includes the ABIG1 Info in its AdvData.

During setup, the ABIG1 Info contained in the BIC_SYNC_CLUSTER_REQ PDU from the slave microphone is matched, except for the ABIG1 Offset and Seed Access Address, to the confirmed ABIG Info in the BIC_SYNC_CLUSTER_CONFIG PDU issued by the master microphone.

The wireless headphones synchronize with the master microphone according to the procedure illustrated in FIG. 15. Once synchronized, they receive BIS PDUs transmitted from both the master and slave microphones based on the CBIG Info and ABIG1 Info, respectively. After decoding, the audio may be played through independent channels or mixed into a single output channel.

To maintain synchronization and prevent clock drift, the slave microphone continuously receives BIC_AUX_SYNC_IND PDUs broadcast by the master microphone. This ensures the ABIG1 Offset remains stable, preventing overlap and maintaining audio synchronization between the master and slave devices.

In one embodiment, a wireless audio data transmission method is applied to a master transmitting device configured to perform broadcast communication with N receiving devices over continuous isochronous intervals, where N is a positive integer. When the master transmitting device is synchronized with M slave transmitting devices, it transmits a broadcast isochronous cluster auxiliary synchronization packet on a second advertising channel. This packet enables receiving devices to synchronize with the master transmitting device and receive both the first broadcast data packet from the master and the second broadcast data packets from the M slave transmitting devices.

Within a given isochronous interval, different broadcast data packets are assigned non-overlapping time slots and/or frequency domain channels to avoid interference. In one embodiment, the different broadcast data packets each carry different audio data, in accordance with an embodiment of the present invention.

In one embodiment, the method further comprises transmitting a synchronization cluster search packet on a first advertising channel and receiving a synchronization cluster request packet from a candidate transmitting device in response. The synchronization cluster request packet includes request link information comprising a device address and a device identifier of the candidate transmitting device. If the master transmitting device determines, based on the device address and identifier, that the candidate device is permitted to join the transmitting device cluster, it transmits a synchronization cluster configuration packet to the candidate device. This configuration packet carries configuration link information used to define the communication parameters of the cluster. Upon receiving a synchronization cluster response packet from the candidate device in response to the configuration packet, the master transmitting device designates the candidate as a slave transmitting device and ensures it is clock-synchronized with the master.

In another embodiment, the master transmitting device transmits a broadcast isochronous cluster auxiliary synchronization packet that includes central link information corresponding to a first communication link group. This link group is used to transmit the first broadcast data packet. The central link information also includes M auxiliary link entries, each corresponding to one of M second communication link groups that support the transmission of second broadcast data packets from M slave transmitting devices. These second communication link groups are mapped one-to-one with the M slave transmitting devices.

In certain embodiments, the central link information further includes P enable parameters, where each parameter is mapped one-to-one with an auxiliary communication link group. Each enable parameter indicates whether the corresponding link group is active. Here, P is an integer greater than or equal to M, and the enabled auxiliary link groups correspond to the active second communication links. This arrangement provides a flexible mechanism for managing link activation. The broadcast isochronous cluster auxiliary synchronization packet is formatted according to the common extended advertising payload structure, with its extended header carrying the central link information. The P enable parameters may occupy all or part of the reserved field within the central link information.

To enhance time-slot management and reduce system complexity, in one embodiment, any two different isochronous intervals—referred to as the first and second isochronous intervals—are structured such that the time-slot positions of both the first broadcast data packet and any target second broadcast data packet remain unchanged between the two intervals. This uniform time-slot positioning avoids reconfiguration overhead and supports deterministic scheduling across multiple intervals.

In another embodiment, the method includes transmitting a target packet from the master transmitting device to any one of the M slave transmitting devices. This target packet enables the selected slave transmitting device to adjust its clock to match that of the master, ensuring clock synchronization. The target packet may be transmitted over either the first or second advertising channel. The first advertising channel is primarily used to identify slave transmitting devices, while the second advertising channel is used by receiving devices to synchronize with the master transmitting device.

In one embodiment, a method is applied to a receiving device operating within a system that includes a transmitting device cluster consisting of a master transmitting device and M clock-synchronized slave transmitting devices. Within each isochronous interval, the receiving device receives a first broadcast data packet from the master transmitting device via a first communication link group, as well as second broadcast data packets from the M slave transmitting devices via their respective second communication link groups. Each of the second communication link groups corresponds to one of the M slave transmitting devices. These packets are arranged such that their transmission time slots and/or frequency channels do not overlap in the same isochronous interval.

Prior to receiving these data packets, the receiving device first synchronizes with the master transmitting device. This synchronization occurs through reception of a broadcast isochronous cluster auxiliary synchronization packet transmitted on a second advertising channel. The synchronization packet contains central link information for the first communication link group and M auxiliary link entries for the second communication link groups. Based on this information, the receiving device establishes synchronization with the master and prepares to receive the associated broadcast data.

The central link information may further comprise P enable parameters, as previously described, to indicate which auxiliary communication link groups are active. This feature allows the receiving device to determine which second communication links should be used to receive additional broadcast data packets.

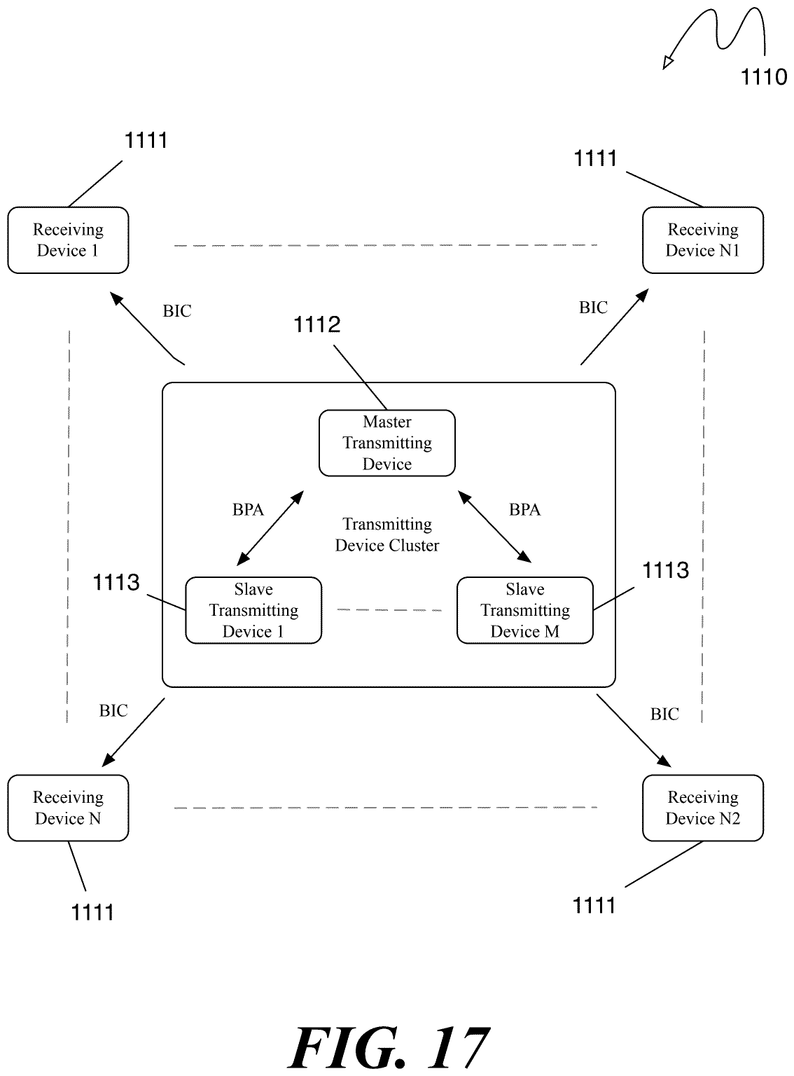

According to one embodiment, a wireless audio data transmission system is provided, as illustrated in FIG. 17. The system 1110 comprises a transmitting device cluster and N receiving devices 1111. The transmitting device cluster includes a master transmitting device 1112 and M slave transmitting devices 1113 that are clock-synchronized with the master transmitting device, where N and M are positive integers. The system supports broadcast communication between the transmitting device cluster and the N receiving devices across continuous isochronous intervals.

In each isochronous interval, the master transmitting device transmits a first broadcast data packet to the N receiving devices via a first communication link group. Concurrently, each of the M slave transmitting devices transmits a second broadcast data packet via its respective second communication link group. The transmission of different broadcast data packets within the same isochronous interval is arranged to avoid overlapping time slots and/or overlapping frequency domain channels.

In one embodiment, both the first and second communication link groups conform to the BLE Audio Broadcast Isochronous Group (BIG) protocol. The structured use of BLE BIG links ensures compatibility with existing BLE audio devices and facilitates multi-device synchronization.

Program code implementing the methods described herein may be written in any suitable programming language and executed by a processor within a general-purpose or specialized computing device. This program code may reside entirely on a single machine, partially on the machine and partially on a remote server, or entirely on a remote system. The system may further include a computer-readable storage medium—such as a ROM, RAM, magnetic disk, or optical disc—on which the program code resides. When executed, the code implements the methods described herein, enabling multi-source wireless audio broadcasting via synchronized broadcast communication links.

While the embodiments described above provide illustrative implementations of the present invention, those skilled in the art will appreciate that various changes, substitutions, and modifications can be made without departing from the spirit and scope of the invention. The appended claims are intended to encompass all such variations and equivalents.

What is claimed is:

1. A wireless audio data transmission method applied to a master device, comprising:
establishing a primary broadcast communication link;
establishing a corresponding secondary broadcast communication link for each of one or more secondary devices; and
broadcasting a primary broadcast data packet via the primary broadcast communication link, and receiving a secondary broadcast data packet broadcast by each secondary device via the corresponding secondary broadcast communication link within one isochronous interval of consecutive multiple isochronous intervals, wherein a time slot for broadcasting the primary broadcast data packet and a time slot for broadcasting the secondary broadcast data packet within the same isochronous interval do not overlap.

2. The method according to claim 1, wherein the primary broadcast communication link and the secondary broadcast communication link corresponding to each of the one or more secondary devices together constitute a broadcast communication link group.

3. The method according to claim 2, wherein the master device and the one or more secondary devices form a distributed transmitter set via a set link, the method further comprising:
transmitting a DTS synchronization search data packet via the set link, and receiving a DTS synchronization set request data packet from a candidate device in response, the DTS synchronization set request data packet comprising request link information including a device address and a device identifier of the candidate device;
transmitting a DTS synchronization set configuration data packet to the candidate device upon determining that the candidate device is permitted to join the distributed transmitter set, the DTS synchronization set configuration data packet comprising link information of the broadcast communication link group and a target identifier; and
receiving a DTS synchronization set response data packet from the candidate device in response to the DTS synchronization set configuration data packet, and designating the candidate device as a secondary device in the distributed transmitter set, wherein the target identifier uniquely identifies the secondary broadcast communication link corresponding to the candidate device within the broadcast communication link group.

4. The method according to claim 1, wherein each isochronous interval comprises multiple sub-event intervals, and wherein:
the broadcasting a primary broadcast data packet via the primary broadcast communication link, and receiving a secondary broadcast data packet broadcast by each secondary device via the corresponding secondary communication link are within one isochronous interval of consecutive multiple isochronous intervals comprises; and
broadcasting a primary broadcast data packet via the primary broadcast communication link, and receiving a secondary broadcast data packet broadcast by each secondary device via the corresponding secondary communication link are within one sub-event interval of the multiple sub-event intervals comprised in the one isochronous interval.

5. The method according to claim 4, wherein, within the sub-event interval, the time slot for broadcasting the primary broadcast data packet precedes the time slot for broadcasting the secondary broadcast data packet.

6. The method according to claim 1, further comprising:
transmitting a target data packet via a first communication channel or a second communication channel, such that each of the one or more secondary devices is clock-synchronized with the master device based on the target data packet, wherein:
the first communication channel is used to identify a secondary device; and
the second communication channel is used for synchronizing devices with the master device.

7. The method according to claim 3, further comprising:
decoding the secondary broadcast data packet received via each secondary broadcast communication link to obtain decoded audio corresponding to each of the one or more secondary devices; down-mixing the decoded audio to obtain mixed audio and playing the mixed audio as mono audio; or playing the decoded audio as multi-channel audio;
wherein the primary broadcast communication link is a primary broadcast isochronous stream link, the secondary broadcast communication link is a secondary broadcast isochronous stream link, and the broadcast communication link group is a distributed broadcast isochronous group; and/or,
wherein the set link is a bidirectional periodic advertising link or a BLE ACL link; and/or,
within one isochronous interval of multiple consecutive isochronous intervals, the audio data carried in the primary broadcast data packet is different from the audio data carried in the secondary broadcast data packet corresponding to each of the one or more secondary devices; and/or,
the method further comprises:
transmitting an auxiliary synchronization PDU carrying link information of the broadcast communication link group via a periodic advertising channel, to enable one or more listener devices to synchronize with the master device based on the auxiliary synchronization PDU and receive both the primary broadcast data packets broadcast by the master device and the secondary broadcast data packets broadcast by the secondary devices by using the broadcast communication link group based on the link information.

8. A wireless audio data transmission method applied to a first secondary device, the method comprising:
establishing a primary broadcast communication link with a master device;
establishing a secondary broadcast communication link through the master device; and
receiving a primary broadcast data packet broadcast by the master device via the primary broadcast communication link, and broadcasting a corresponding secondary broadcast data packet via the secondary broadcast communication link, and/or receiving a secondary broadcast data packet broadcast by a second secondary device via a secondary broadcast communication link corresponding to the second secondary device, wherein the operations are performed within one isochronous interval of consecutive multiple isochronous intervals, and wherein a time slot for broadcasting the primary broadcast data packet and a time slot for broadcasting the secondary broadcast data packet within the same isochronous interval do not overlap.

9. The method according to claim 8, wherein the primary broadcast communication link and the secondary broadcast communication link corresponding to each of the one or more secondary devices together constitute a broadcast communication link group.

10. The method according to claim 9, wherein the master device and the one or more secondary devices form a distributed transmitter set via a set link, and establishing the secondary broadcast communication link through the master device comprises:
receiving a DTS synchronization search data packet from the master device via the set link;
transmitting a DTS synchronization set request data packet to the master device, the request data packet comprising request link information including a device address and a device identifier of the first secondary device;
receiving a DTS synchronization set configuration packet from the master device, the packet comprising link information of the broadcast communication link group and a target identifier;
transmitting a DTS synchronization set response packet to the master device; and
establishing the secondary broadcast communication link based on the link information, wherein the first secondary device is designated as a secondary device in the distributed transmitter set, and the target identifier uniquely identifies the secondary broadcast communication link corresponding to the first secondary device within the broadcast communication link group.

11. The method according to claim 10, wherein: the primary broadcast communication link is a primary broadcast isochronous stream link; the secondary broadcast communication link is a secondary broadcast isochronous stream link; the broadcast communication link group is a distributed broadcast isochronous group; and/or the set link is a bidirectional periodic advertising link or a BLE ACL link.

12. A wireless audio data transmission system comprising:
a master device and one or more secondary devices;
wherein the master device establishes a primary broadcast communication link with the one or more secondary devices, and each secondary device establishes a corresponding secondary broadcast communication link through the master device; and the master device is configured for:
broadcasting a primary broadcast data packet via the primary broadcast communication link, and receiving a secondary broadcast data packet broadcast by each secondary device via the corresponding secondary communication link within one isochronous interval of consecutive multiple isochronous intervals; and
wherein a time slot for broadcasting the primary broadcast data packet and a time slot for broadcasting the secondary broadcast data packet within the same isochronous interval are not overlapped with each other.

13. The system according to claim 12, wherein the primary broadcast communication link and the secondary broadcast communication link corresponding to each of the one or more secondary devices together constitute a broadcast communication link group.

14. The system according to claim 13, wherein the master device and the one or more secondary devices form a distributed transmitter set via a set link, and the master device is further configured to:
transmit a DTS synchronization search data packet via the set link;
receive a DTS synchronization set request data packet from a candidate device, the request comprising a device address and a device identifier;
transmit a DTS synchronization set configuration data packet to the candidate device upon determining permission, the configuration packet comprising link information of the broadcast communication link group and a target identifier; and
receive a DTS synchronization set response packet from the candidate device and designate it as a secondary device, such that the candidate device establishes a corresponding secondary broadcast communication link using the link information, wherein the target identifier uniquely identifies the secondary broadcast communication link corresponding to the candidate device within the broadcast communication link group.

15. The system according to claim 14, wherein:
the primary broadcast communication link is a primary broadcast isochronous stream link;
the secondary broadcast communication link is a secondary broadcast isochronous stream link;
the broadcast communication link group is a distributed broadcast isochronous group; and/or
the set link is a bidirectional periodic advertising link or a BLE ACL link.

16. The system according to claim 13, further comprising one or more listener devices, wherein each listener device is configured to:
receive an auxiliary synchronization PDU transmitted by the master device via a periodic advertising channel, the PDU carrying link information of the broadcast communication link group;
synchronize with the master device based on the auxiliary synchronization PDU; and
receive the primary broadcast data packet via the primary broadcast communication link, and receive the secondary broadcast data packets via the corresponding secondary communication links using the broadcast communication link group.

17. A wireless audio data transmission system, comprising:
a transmitting device cluster comprising a master transmitting device and one or more slave transmitting devices synchronized with the master transmitting device; and
one or more receiving devices;
wherein, in one of multiple consecutive isochronous intervals: the master transmitting device is configured to transmit a first broadcast data packet to the receiving devices via a first communication link group; and each slave transmitting device is configured to transmit a corresponding second broadcast data packet to the receiving devices via a corresponding second communication link group;
wherein the first broadcast data packet and the second broadcast data packets occupy non-overlapping time slots and/or non-overlapping frequency domain channels.

18. The system according to claim 17, wherein: the first and second communication link groups are Broadcast Isochronous Group (BIG) links; and each broadcast data packet transmitted in an isochronous interval carries different audio data.

19. The system according to claim 17, wherein the master transmitting device is further configured to:
transmit a synchronization cluster search packet over a first advertising channel;
receive a synchronization cluster request packet from a candidate transmitting device, the request comprising a device address and a device identifier;
transmit a synchronization cluster configuration packet to the candidate transmitting device, the configuration packet comprising configuration link information; and
receive a synchronization cluster response packet from the candidate transmitting device and designate it as a slave transmitting device configured to establish a second communication link group using the configuration link information.

20. The system according to claim 19, wherein the master transmitting device is further configured to:
transmit a broadcast isochronous cluster auxiliary synchronization packet over a second advertising channel, the packet comprising a central link information of the first communication link group; and an auxiliary link information of the second communication link groups; and
wherein the auxiliary synchronization packet is used by the receiving devices to synchronize with the master transmitting device and to receive the first and second broadcast data packets via the respective communication link groups.
